(19) United States
(12) Patent Application Publication
(10) Pub. No.: US 2016/0179798 A1
(43) Pub. Date: Jun. 23, 2016

(54) METHOD AND SYSTEM FOR NAVIGATING THROUGH A DATACENTER HIERARCHY IN A MOBILE COMPUTER DEVICE

(71) Applicant: Blackboard Inc., Washington, DC (US)

(72) Inventors: Matthew Peter Franks, Austin, TX (US); Patrick Fabian Marsh, JR., Austin, TX (US); Charles Martin Fisher, Austin, TX (US); Philip Spencer Knapp, Austin, TX (US); Justin Edward Boyce, Austin, TX (US); Lauren Briana Mazzio, Austin, TX (US); Eric Alan Boggs, Austin, TX (US); Jonathan Kolko, Austin, TX (US)

(21) Appl. No.: 14/578,084

(22) Filed: Dec. 19, 2014

(51) Int. Cl. G06F 17/30; G06F 3/0481; G06F 3/0487; H04L 29/08; G06F 3/0482

(52) U.S. Cl. CPC G06F 17/30011; H04L 67/02; G06F 3/0482; G06F 3/0487; G06F 3/04817

(57) ABSTRACT

A graphical user interface system is provided. The system includes a display configured to provide a plurality of panels, each panel associated with a document in a datacenter, wherein the datacenter comprises an architecture having a plurality of hierarchy layers, each hierarchy layer storing at least a document; a memory storing commands; and a processor coupled to the display and configured to execute the commands to cause the graphical user interface to navigate through the datacenter architecture by: receiving a first user gesture to access a first hierarchy layer in the datacenter; receiving a second user gesture to access a second hierarchy layer in the datacenter; and displaying in the display a visual effect when at least one of the first hierarchy layer and the second hierarchy layers are accessed. An apparatus including a graphical user interface system as above and a method for its use are also provided.

### FIELD

The present disclosure is related to viewing data on an electronic device, and more particularly to navigating through an academic database using a mobile computer device.

### BACKGROUND

The increasing capabilities of computer hardware and network connectivity have led to the development of highly sophisticated datacenters. These datacenters are accessible by multiple users, typically via a mobile computer device, and include architectures with a high degree of branching. Furthermore, the massive amount of data that is collected into, stored in, and provided from such datacenters introduces an extra degree of complexity for the handling of the data. The demands for a mobile computer device are increased, due to the limited display area, memory space, processing capability, and power availability of such devices. This is exacerbated by the desirability of simple data handling schemes in mobile devices, as these devices are expected to adapt to an increasing user mobility and reduced form factor of new mobile computer devices. Accordingly, it has become highly desirable to have a system and a method for handling the ever increasing complexity of modern datacenters in a manner that is transparent to the user.

One area where the above issues are particularly relevant is the handling of an instructional datacenter for an educational institution. In these instances, while the instructional datacenter may have a number of sophisticated features, the software installed on each mobile device to navigate through the complexity of the datacenter may not be adequate. For example, the user interface may not lend itself to a simple use, particularly with a reduced number of ‘clicks’ and other keyboard manipulation from the user.

To the extent that institutions do provide instructional content configured for viewing on mobile devices, they have relatively complicated and confusing user interfaces. Users of these mobile devices who require different types of information related to their institution, or require information to supplement a web page they are viewing, are typically required to manually locate a subsequent web page or function from among a large array of potential institutional pages to obtain the information they seek, thereby complicating the user's task of interacting with the system. These complications further hinder the widespread use of the mobile medium for institutional purposes.

### SUMMARY

A graphical user interface system according to embodiments disclosed herein includes a display configured to provide a plurality of panels, each panel associated with a document in a datacenter, wherein the datacenter comprises an architecture having a plurality of hierarchy layers, each hierarchy layer storing at least a document; a memory storing commands; and a processor coupled to the display and configured to execute the commands to cause the graphical user interface to navigate through the datacenter architecture by: receiving a first user gesture to access a first hierarchy layer in the datacenter; receiving a second user gesture to access a second hierarchy layer in the datacenter; and displaying in the display a visual effect when at least one of the first hierarchy layer and the second hierarchy layers are accessed.

A mobile computer device according to some embodiments includes a communications module configured to access a datacenter in a remote server through a network, the datacenter having an architecture comprising a plurality of hierarchy levels; a display configured to provide a plurality of panels, each panel associated with a document in the datacenter, a memory storing commands; and a processor configured to execute the commands to cause the display to navigate through the datacenter architecture by: receiving a first user gesture to access a first hierarchy layer in the datacenter; receiving a second user gesture to access a second hierarchy layer in the datacenter; and displaying, in the display, a visual effect when at least one of the first hierarchy layer and the second hierarchy layer are accessed.

A non-transitory, computer-readable medium as disclosed herein includes instructions which, when executed by a processor circuit coupled to a display and a memory, the memory comprising a graphical user interface, cause the display to perform a method including: receiving a first user gesture to access a first hierarchy layer in the datacenter; receiving a second user gesture to access a second hierarchy layer in the datacenter; and displaying in the display a visual effect when at least one of the first hierarchy layer and the second hierarchy layers are accessed.

According to some embodiments, a method for navigating through a datacenter hierarchy in a mobile computer device, includes: receiving a first user gesture to access a first hierarchy layer in the datacenter architecture; receiving a second user gesture to access a second hierarchy layer in the datacenter architecture; and providing a visual effect based on the first and second user gestures and the location in the datacenter of a document displayed on the display.

In yet other embodiments, a graphical user interface includes a display configured to provide a plurality of panels, each panel associated with a document in a datacenter; a memory storing commands; and a processor coupled to the display and configured to execute the commands to cause the display to provide a status icon when a user is performing one of uploading a first document to the datacenter, or downloading a second document from the datacenter.

In further embodiments, a method for handling a graphical user interface in a network connection between a mobile computer device and a remote server includes: determining the state of a datacenter transaction between the mobile computer device and the remote server; detecting a geo-location of the mobile computer device; and providing a status icon and status text according to the state of the datacenter operation and the geo-location of the mobile computer device.

In some embodiments, a method for handling a graphical user interface in a network connection between a mobile computer device and a remote server hosting a datacenter includes: providing a first input direction on a touch screen display for navigating between a plurality of hierarchy layers in the datacenter; and providing a second input direction on the touch screen display for navigating within each of the plurality of hierarchy layer in the datacenter.

### BRIEF DESCRIPTION OF THE DRAWINGS

FIG. 1 is a diagram illustrating a mobile delivery system for institutional content according to certain embodiments.

FIG. 2 illustrates a graphical user interface module to provide a navigation display in a mobile computer device, according to some embodiments.

FIG. 3A illustrates a navigation display used in a plurality of operating systems for different mobile computer device orientations, according to some embodiments.

FIG. 3B illustrates a navigation display used in an operating system for different tablet device orientations, according to some embodiments.

FIG. 3C illustrates a navigation display used in a plurality of operating systems for different tablet device orientations, according to some embodiments.

FIG. 4A illustrates a navigation feature for accessing deeper items in the datacenter hierarchy from a base location, according to some embodiments.

FIG. 4B illustrates a navigation feature for accessing deeper items in the datacenter hierarchy, such as selecting a course from a course list, according to some embodiments.

FIG. 4C illustrates a navigation feature for accessing deeper items in the datacenter hierarchy, such as a document list within a course selected from the course list, according to some embodiments.

FIG. 4D illustrates a navigation feature for accessing deeper items in the datacenter hierarchy, such as a document selected from the document list in the course, according to some embodiments.

FIG. 5A illustrates a swipe invoke and dismiss motion definition for navigating through a datacenter hierarchy, according to some embodiments.

FIG. 5B illustrates a tap invoke and dismiss motion definition for navigating through a datacenter hierarchy, according to some embodiments.

FIG. 5C illustrates a scroll main layer motion definition for navigating through a datacenter hierarchy, according to some embodiments.

FIG. 5D illustrates a rapid swipe back definition for navigating through a datacenter hierarchy, according to some embodiments.

FIG. 5E illustrates a plurality of navigation buttons for navigating through a datacenter hierarchy, according to some embodiments.

FIG. 5F illustrates a dynamic view of a scroll main layer motion definition for navigating through a datacenter hierarchy, according to some embodiments.

FIG. 5G illustrates a dynamic view of an asymmetrical navigation through a datacenter hierarchy, according to some embodiments.

FIG. 6A illustrates a linear exit and rapid swipe tool for returning to higher layers in a datacenter hierarchy such as leaving a document to access a document list within a course, according to some embodiments.

FIG. 6B illustrates a linear exit and rapid swipe tool for returning to higher layers in a datacenter hierarchy such as leaving the document list to access a course list, according to some embodiments.

FIG. 6C illustrates a linear exit and rapid swipe tool for returning to higher layers in a datacenter hierarchy such as leaving the course list to access the base location; according to some embodiments.

FIG. 7A illustrates an asymmetric exit tool including a slow swipe and a menu button to navigate away from a deep layer in a datacenter hierarchy such as leaving a document from within a course, according to some embodiments.

FIG. 7B illustrates an asymmetric exit tool including a slow swipe and a menu button to navigate away from a deep layer in a datacenter hierarchy such as leaving a document list into a course contents list, according to some embodiments.

FIG. 7C illustrates an asymmetric exit tool including a slow swipe and a menu button to navigate away from a deep layer in a datacenter hierarchy such as scrolling down from a list of items in a base location, according to some embodiments.

FIG. 8A illustrates a navigation tool between sibling items in a datacenter hierarchy such as accessing course lists associated with different semesters, according to some embodiments.

FIG. 8B illustrates a navigation tool between sibling items in a datacenter hierarchy where the user scrolls a long sibling page and the title of the page is pushed into the header bar, according to some embodiments.

FIG. 9A illustrates a navigation tool between sibling items in a datacenter hierarchy including a swipe through sections gesture and a tap through sections gesture, according to some embodiments.

FIG. 9B illustrates a navigation tool between sibling items in a datacenter hierarchy including a page to page transition, an open course transition, and a search transition, according to some embodiments.

FIG. 9C illustrates a navigation tool between sibling items in a datacenter hierarchy including a header, according to some embodiments.

FIG. 9D illustrates a dynamic view of a swipe through sibling items to view a right section in a datacenter hierarchy, according to some embodiments.

FIG. 9E illustrates a dynamic view of a swipe through sibling items to view a left section in a datacenter hierarchy, according to some embodiments.

FIG. 10A illustrates a tablet navigation tool for accessing deeper items in the datacenter hierarchy starting at the base location, according to some embodiments.

FIG. 10B illustrates a tablet navigation tool for accessing deeper items in the datacenter hierarchy including a show/hide tool for the menu, according to some embodiments.

FIG. 10C illustrates a tablet navigation tool for accessing deeper items in the datacenter hierarchy hiding the menu, according to some embodiments.

FIG. 11A illustrates an invoke/dismiss motion for navigating through a datacenter hierarchy with a tablet device, according to some embodiments.

FIG. 11B illustrates a swipe/tap through sections motion for navigating through a datacenter hierarchy with a tablet device, according to some embodiments.

FIG. 11C illustrates a page to page transition in a tablet navigation through a datacenter hierarchy, according to some embodiment.

FIG. 12A illustrates a swipe to dismiss tool for tablet navigation through a datacenter hierarchy where a child layer is dismissed and the parent layer remains on display, according to some embodiments.

FIG. 12B illustrates tap to fan tool for tablet navigation through a datacenter hierarchy including an overlay area that receives a tap gesture, according to some embodiments.

FIG. 12C illustrates tap to fan tool for tablet navigation through a datacenter hierarchy where a tap gesture on a menu icon reveals a navigation panel is displayed, according to some embodiments.

FIG. 13A illustrates a child page dismissal tool including a swipe to dismiss gesture in a tablet navigation through a datacenter hierarchy, according to some embodiments.

FIG. 13B illustrates a child page dismissal tool including a tap to fan gesture in a tablet navigation through a datacenter hierarchy, according to some embodiments.

FIG. 14A illustrates a tablet navigation tool between sibling items in a datacenter hierarchy including a swipe through sections gesture and a tap through sections gesture, according to some embodiments.

FIG. 14B illustrates a tablet navigation tool between sibling items in a datacenter hierarchy including a page to page transition, an open course transition, and a search transition, according to some embodiments.

FIG. 14C illustrates a tablet navigation tool between sibling items in a datacenter hierarchy including a header, according to some embodiments.

FIG. 14D illustrates a status icon displayed when a user is performing one of uploading or downloading a document to the datacenter.

FIG. 15 is a flow chart illustrating steps in a method for navigating through a datacenter hierarchy in a mobile computer device, according to some embodiments.

FIG. 16 is a flow chart illustrating steps in a method for navigating through a datacenter hierarchy in a mobile computer device, according to some embodiments.

FIG. 17 is a flow chart illustrating steps in a method for displaying a state of a datacenter operation, according to some embodiments.

FIG. 18 is a block diagram illustrating an example computer system with which the personal computing device and server of FIG. 1 can be implemented.

### DETAILED DESCRIPTION

The present disclosure describes methods and systems to facilitate user navigation of complex datacenter architectures. In some embodiments, the user accesses the datacenter remotely using a mobile computer device such as a smartphone or a tablet computer device communicating with a network. The datacenter may be hosted by a server managed by an institutional client. In some embodiments, the institutional client is an educational institution, and the users are students, faculty, and administrators in the educational institution. Embodiments consistent with the present disclosure provide a simple and user-friendly manner to navigate through different hierarchy layers in the datacenter architecture, which is relevant for users of mobile computer devices having limited space in a touch screen display.

Embodiments consistent with the present disclosure provide a simple way for a user to navigate between a hierarchy layer, a child hierarchy layer, and a grandchild hierarchy layer in datacenter architectures, by using different input gestures on a touch screen device. More specifically, embodiments consistent with the present disclosure enable a user navigating through the datacenter to have a close grasp of the different hierarchy layers forming the architecture of the datacenter. For example, in a single display the user may easily see a hierarchy layer, a child hierarch layer, and a grandchild hierarchy layer, and navigate from either one of them to any of the other layers without having to retrace the path that lead to the current hierarchy layer that the user is accessing.

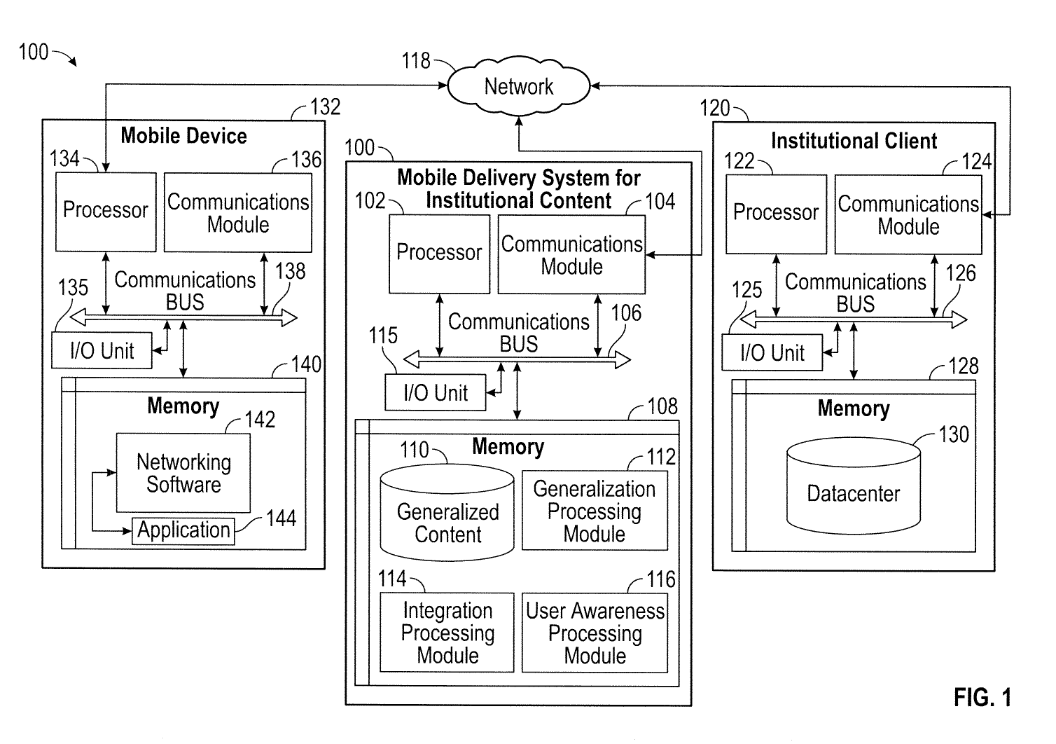

FIG. 1 is a diagram illustrating a mobile delivery system for institutional content 100 (hereinafter “system 100”) according to certain embodiments. System 100 includes a processor 102, communications module 104, and memory 108, each connected by a communications bus 106. System 100 is configured to be connected to one or many institutional clients 120 and one or many mobile computer devices 132 over a network 118. In some embodiments, system 100 includes an input/output (I/O) unit 115 for a user interface. Accordingly, I/O unit 115 may include a keyboard or a touch-screen display that enables the user to provide commands to and retrieve data from mobile delivery system 100. For example, the user may be a technician providing regular maintenance operations on mobile delivery system 100 using I/O unit 115.

In some embodiments, system 100 represents a computer or a laptop computer. In certain embodiments, with appropriate processing power, system 100 can represent a server, a thin client, a personal digital assistant (PDA), a portable computing device, a mobile intelligent device (MID) (e.g., a smartphone), a software as a service (SAAS), or a suitable device with a processor 102 and memory 108. System 100 can be stationary or mobile and may also be managed by a host, such as over a network 118. System 100 is wired or wirelessly connected to network 118 via a communications module 106. Communications module 106 is connected to network 118, for example, via a modem connection, a local-area network (LAN) connection including the Ethernet, or a broadband wide-area network (WAN) connection, such as a digital subscriber line (DSL), cable, T1, T3, fiber optic, or satellite connection. In the illustrated embodiment, the network 118 is the Internet, although in certain embodiments, network 118 can be a LAN network or a corporate WAN network. Network 118 may include features such as a firewall.

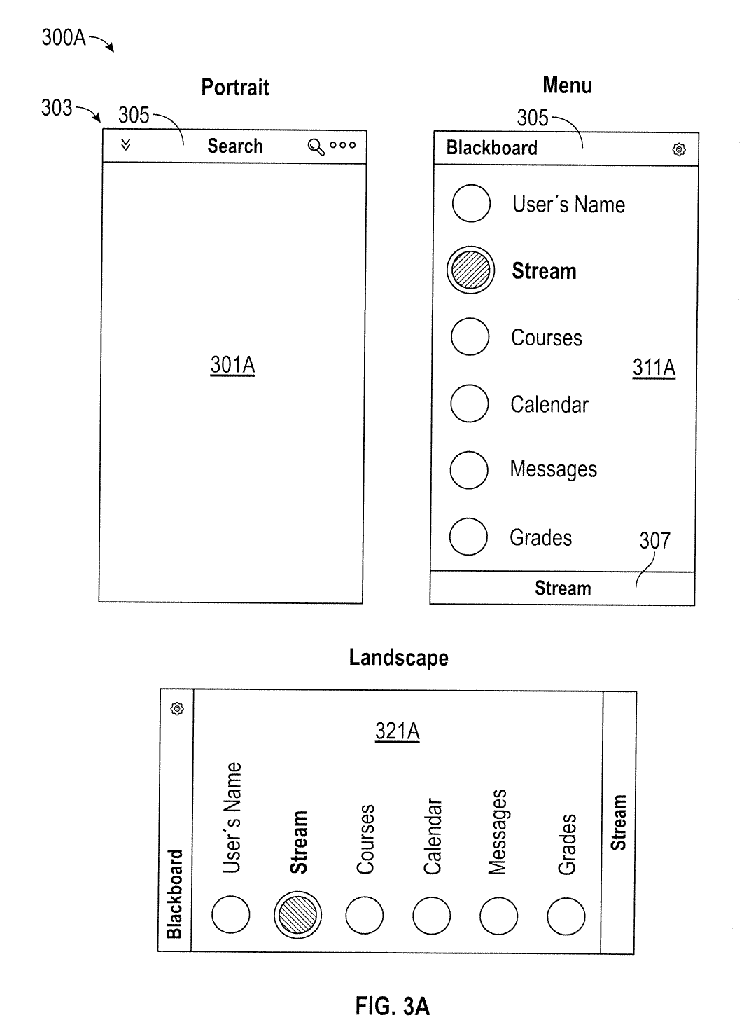

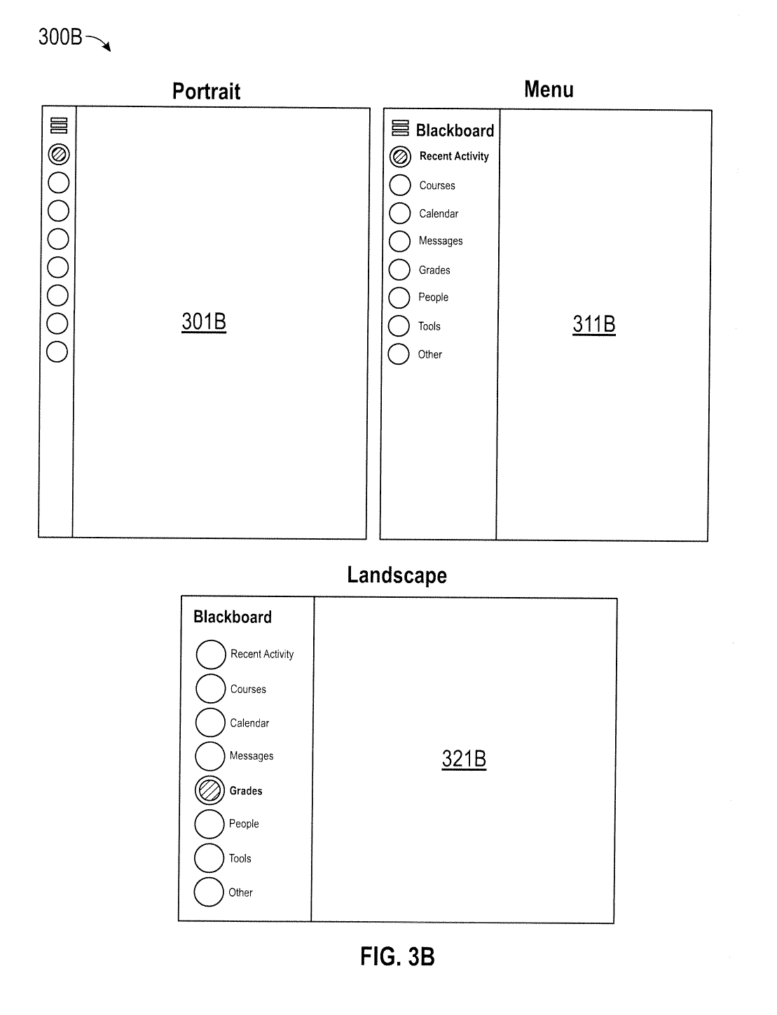

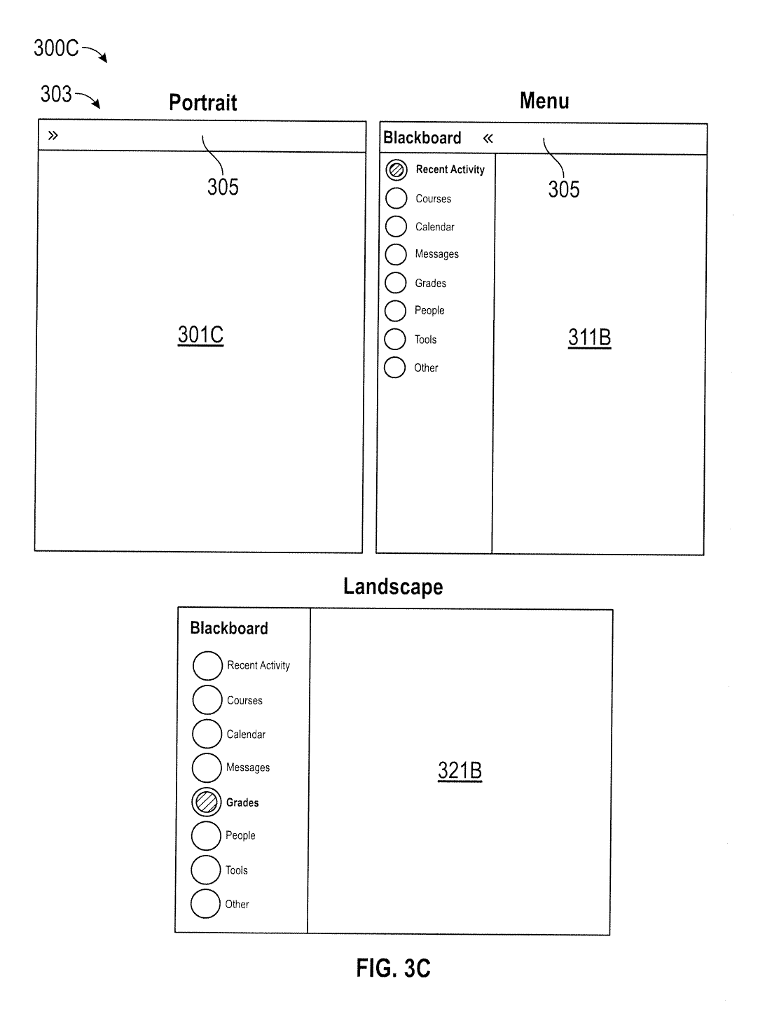

Computer-readable memory 108 of system 100 includes a generalization processing module 112, integration processing module 114, a user awareness processing module 116, and a generalized content data store 110. Generalization processing module 112, integration processing module 114, and a user awareness processing module 116 may be a single software application, individual software applications, or may each comprise multiple software applications. Generalization processing module 112 stores computer-readable instructions executable by the processor 102 to receive client-specific data in one or many client-specific data files from a datacenter 130. In embodiments consistent with the present disclosure, generalization processing module 112 is optional. Accordingly, embodiments consistent with the present disclosure may omit generalization processing module 112 and still be able to provide most, or all of the navigation features disclosed herein. Datacenter 130 includes client specific content and data, arranged in an architecture having a plurality of hierarch layers. Client-specific data includes, for example, data that is stored in a format specific to the client (e.g., institutional client 120), such as a file format (e.g., PDF, TXT, and XML files) or format within the file (e.g., a specific tag identifying a student may be given different names at different institutions). In some embodiments, client specific data may include data stored in a datacenter having an architecture including a plurality of hierarchy layers. Generalization processing module 112 stores computer-readable instructions executable by the processor 102 to extract instances of client-specific data from the client-specific content data file that match a target type. For example, generalization processing module 112 is configured to parse through the client-specific content data files of datacenter 130 and extract client-specific data matching various data types, including, but not limited to, map data, news data, athletics data, events data, videos data, images data, directory data, and courses data, as discussed with reference to FIGS. 3A-14C below. In certain embodiments, the data types are identified based on identifiers associated with the client-specific data. For example, the identifier can be a meta tag, such as the meta tag “name” for a student name. As another example, the identifier can be a comma and/or line format, such as where certain types of data separated by commas appear in a certain order. Additional details regarding identifying data types to extract are discussed below, again with reference to FIGS. 3A-14C.

Information from datacenter 130 is received, for example, from an institutional client 120 via its communications module 124 and the system's communications module 104 over the network 118. Institutional client 120 includes an input/output (I/O) unit 125 for a user interface. Accordingly, I/O unit 125 may include a keyboard or a touch-screen display that enables the user to provide commands to and retrieve data from institutional client 120. As in the case of I/O unit 115, I/O unit 125 may be used by a technician or administrator performing maintenance or administrative operations on institutional client 120. Datacenter 130 may store data in various formats, including, but not limited to: a database, a SQL-extract, text file, web feed format such as an XML feed or Really Simple Syndication (RSS) feed, Microsoft Excel® file, or Microsoft Word® file. In certain embodiments, datacenter 130 is stored in memory 128 at the institutional client 120, such as in a comma separated file format, while in certain embodiments, datacenter 130 is stored in memory 128 on a third-party server accessible by the system 100, such as in a web feed format.

The generalization processing module 112 also stores computer-readable instructions executable by the processor 102 to store the extracted data in the generalized content data store 110. For example, the extracted data may be temporarily stored in volatile memory (e.g., RAM), or stored for later use in non-volatile memory (e.g., a hard disk drive). In certain embodiments, the extracted data that is stored as generalized data is platform-independent, e.g., it is not specific to any platform, model, or device type. In certain embodiments, client-specific data can be extracted directly from datacenter 130 of the institutional client 120 upon request from a mobile computer device (“real-time”), where it may or may not be stored in the generalized content data store 110. For example, if datacenter 130 is dynamically or frequently updated, it may be beneficial to extract client-specific data from datacenter 130 at the institutional client 120 in real-time, such that the extracted client-specific data is up-to-date. In certain embodiments, the client-specific data can be extracted on a predetermined schedule, whereupon it is stored in the generalized content data store 110. For example, if datacenter 130 is infrequently updated or updated on a fixed schedule, it may be beneficial to extract client-specific data from the datacenter 130 at the institutional client 120 on a predetermined schedule and store the extracted data in the memory of the system 100 (e.g., in the generalized content data store 110) in order to reduce the processing burden of the system 100 in response to multiple requests, and to reduce the burden on the network connection 118 between the system 100 and the institutional client 120. In certain embodiments, the generalized content data store 110 is a database, such as a SQL database. Although in the illustrated embodiment the generalized content data store 110 is stored in the memory 108 of the system 100, in certain embodiments, the generalized content data store 110 is stored in memory 128 at the institutional client 120.

The integration processing module 114 stores computer-readable instructions executable by the processor 102 to receive an integrated information request for base-to-target data, obtain the target data based on the base information provided in the request, and then return the target data. For example, in response to an integrated information request targeting a location of a building on a map requested over the network 118 from a base web page of a mobile computer device 132 listing information on the building, the system 100 would obtain the location of the building on a map formatted for mobile viewing, and return the map highlighting the location of the building to the mobile computer device 132. System 100 is configured to process various types of integrated information requests, including, but not limited to, a request for target maps data from a base course web page, a request for target directory data from a base course web page, a request for target directory data from a base events web page, a request for target maps data from a base events web page, a request for target maps data from a base directory web page, a request for target maps data from a base dining places web page, and a request for target maps data from a base library web page. Target data can be obtained either in real-time directly from the institutional client 120, or from the generalized content data store 110 of the system 100.

The user awareness processing module 116 stores computer-readable instructions executable by the processor 102 to provide a user with options to access mobile institutional content that is specific to (or “aware of”) the user. For example, the mobile content can be specific to the user's geographic location, account, social network, profile, and other information. The user may be identified by an authentication system provided by the user awareness processing module 116, such as by, without limitation, a username, password, and/or other credentials for the purposes of accounting, security, logging, and resource management.

Institutional client 120 can represent a computer or a laptop computer. In certain embodiments, with appropriate processing power, institutional client 120 is a server, a thin client, a personal digital assistant (PDA), a portable computing device, a mobile intelligent device (MID), a system as a service (SAAS), or a suitable device with a processor 122 and memory 128. Institutional client 120 can be stationary or mobile. Institutional client 120 may also be managed by a host, such as over network 118. Institutional client 120 may be physically located at the institution, such as at a university campus, or remotely located away from the actual campus.

Mobile computer device 132 can be a device configured for mobile use that includes a memory 140, processor 134, and communications module 136 that communicate over a communications bus 138. Mobile computer device 132 includes an input/output (I/O) unit 135 for a user interface. Accordingly, I/O unit 135 may include a keyboard or a touch-screen display that enables the user to provide commands to and retrieve data from mobile computer device 132. Exemplary mobile computer devices 132 include, but are not limited to, cellular telephones, MIDs, and PDAs. Well known mobile computer devices 132 that are configurable for use with the disclosed system 100 include the APPLE® IPHONE® and the BLACKBERRY STORM®. Other mobile computer devices 132 from these and other manufacturers can also be used, such as tablet computers and devices. Well known tablet devices that may be used in embodiments of the present disclosure include APPLE® IPAD® and related devices by other manufacturers. The mobile computer device 132 is configured to view the generalized content 110 of the system 100 using networking software 142, such as a web browser, that retrieves the generalized content 110 over the network 118 using the mobile computer device's communications module 136. Networking software 142 may be coupled to an application 144 that specifically allows the user of mobile device 132 to access information from datacenter 130 in institutional client 120.

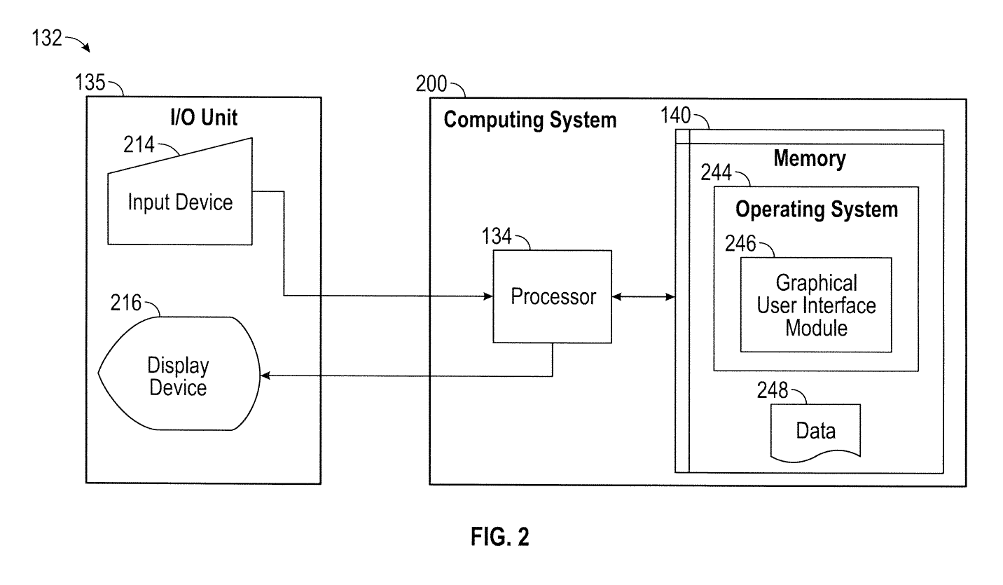

FIG. 2 illustrates a graphical user interface module 246 to provide a navigation display in mobile computer device 132, according to some embodiments. Mobile computer device 132 includes a computing system 200 having processor 134 coupled to a display device 216. Processor 134 is also coupled to an input device 214. Accordingly, input device 214 and display device 216 may be included within I/O unit 135. Computing system 200 includes memory 140 having an operating system 104 including a graphical user interface module 246.

Processor 134 is configured to execute instructions that may be physically coded into processor 134 (“hard coded”), received from software such as graphical user interface module 246, stored in memory 140, or a combination of both. In certain embodiments, graphical user interface module 246 is associated with the functionality of displaying windows on display device 216 for computer system 200 running an operating system 244. As one example, and without limitation, mobile computer device 132 is an APPLE® IPAD® or an APPLE® IPHONE®, processor 134 is an 1 GHz APPLE® A4 processor, and I/O unit 135 is a touch screen liquid crystal display (LCD). For example, some embodiments may include operating system such as IOS® (for Apple), ANDROID® (Motorola, Lenovo), or WINMO® (Microsoft) for mobile computer devices 132 manufactured by different vendors. Embodiments consistent with the present disclosure provide navigation capabilities across device form factors (tablet/mobile), orientation (landscape/portrait), and operating system/platform (IOS/android/Winmo). Navigation features as disclosed herein are included in graphical user interface module 246 to provide the user of mobile computer device 132 with a fluid, rapid and reliable access to different hierarchy layers of datacenter 130.

Other exemplary mobile computer devices 132 include laptop computers, tablet computers, servers, clients, thin clients, personal digital assistants (PDA), portable computing devices, mobile intelligent devices (MID) (e.g., a smartphone), software as a service (SAAS), or suitable devices with processor 134 and memory 140. Other exemplary input devices 214 include mice and keyboards. Other exemplary display devices 216 include organic light emitting diodes (OLED) and cathode ray tubes (CRT).

FIG. 3A illustrates a navigation display 300A used in a plurality of operating systems for different mobile computer device orientations, according to some embodiments. Embodiments consistent with FIG. 3A include mobile computer devices 132 having a reduced form factor, such as a smartphone. Accordingly, display 301A for a portrait configuration uses the entire screen to display the content of a page or document in datacenter 130 with the device positioned in a vertical orientation relative to the user. A menu button 303 on a title bar 305 brings menu display 311A. In this embodiment, the menu takes the entire screen of the device, so as to clearly show the icons in the menu to the user. A bottom bar 307 provides user access to previously visited pages or content within datacenter 130. In that regard, bottom bar 307 may include more than one page or document belonging to a plurality of hierarchy layers in datacenter 130. When the user turns the device into a horizontal orientation, the portrait display configuration is preserved in display 321A.

FIG. 3B illustrates a navigation display 300B used in an operating system for different tablet device orientations, according to some embodiments. Portrait display 301B shows menu items compressed to one side of the screen (i.e., the left side), to maximize the content display of the screen. As can be seen, the different items in the menu are still accessible to the user. Menu display 311B expands the menu over the content display of the page, still in a portrait orientation. Since mobile computer device 132 is a tablet device in this case, there is more room in the screen to maintain a content display in this configuration. When the user places the tablet device in a horizontal configuration, a landscape display 321B provides a more complete view of the page content without need to reduce the menu display.

FIG. 3C illustrates a navigation display 300C used in a plurality of operating systems for different tablet device orientations, according to some embodiments. In navigation display 300C the tablet is in portrait orientation and display 301C collapses the menu entirely, to maximize the content display of the screen. The menu may be retrieved back into display 311B or 321B simply by tapping on menu button 303 placed on task bar 305.

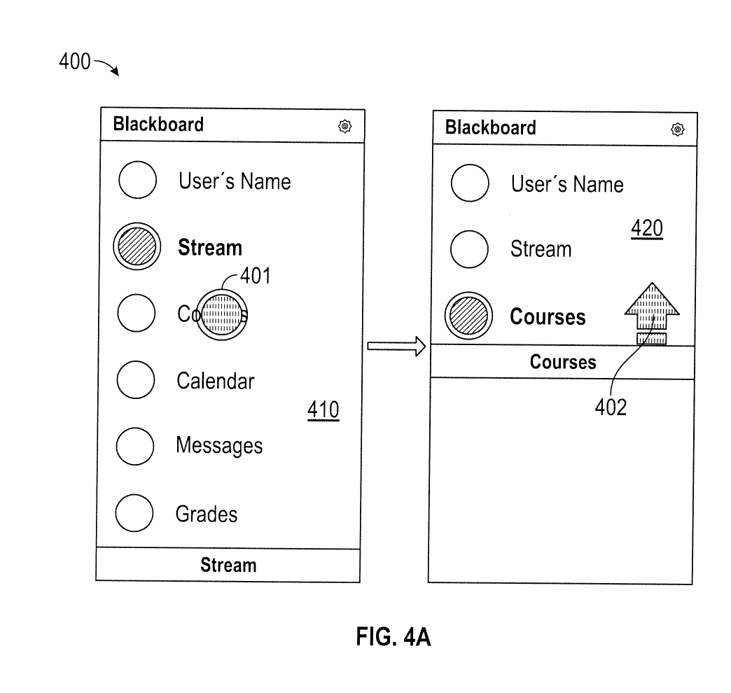

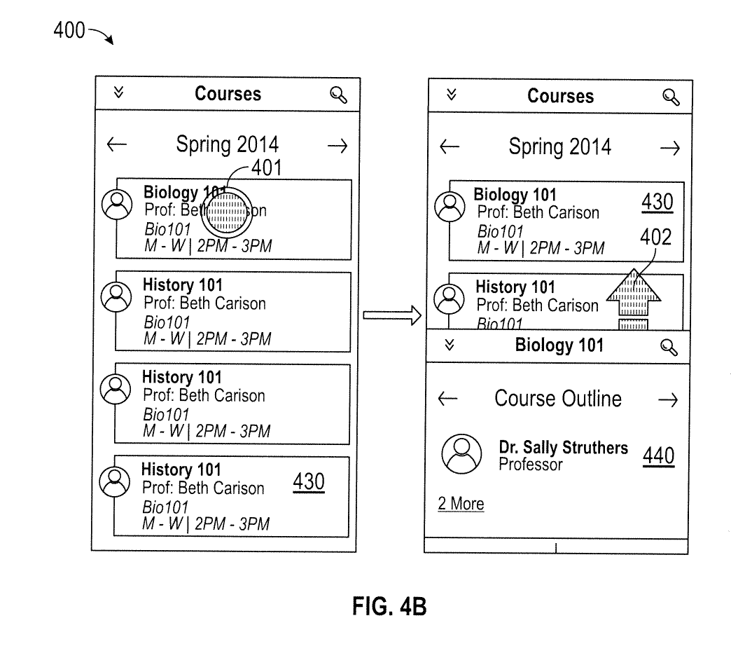

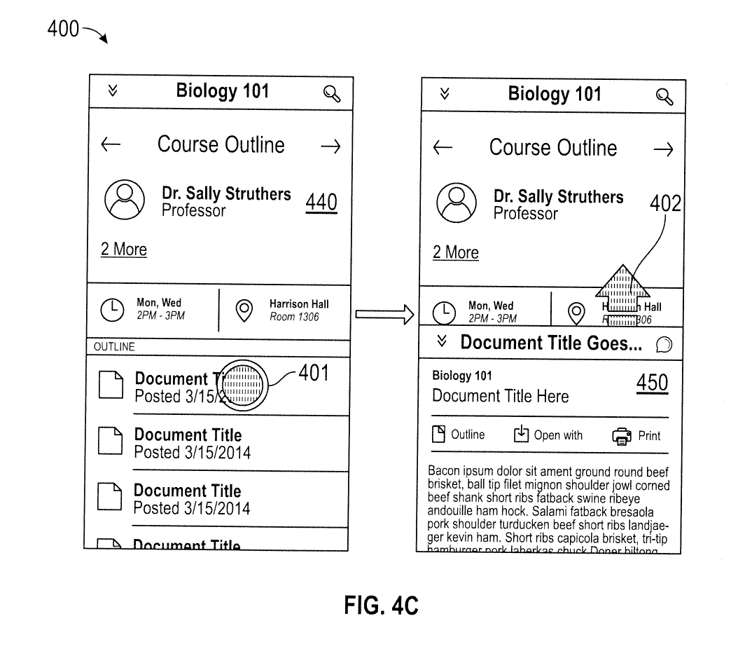

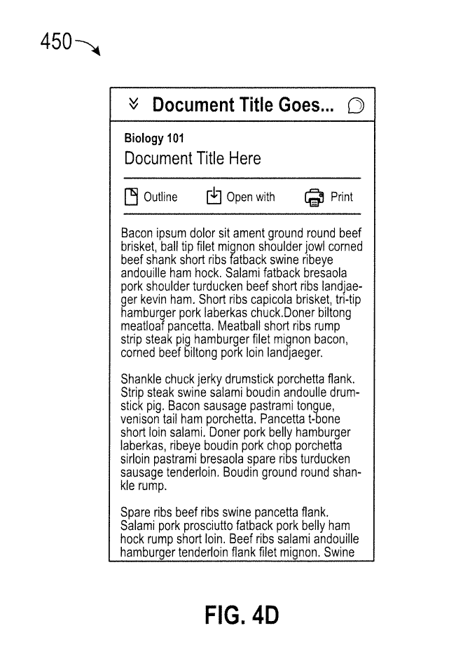

FIG. 4A illustrates a navigation feature 400 for accessing deeper items in the datacenter hierarchy from a base location, according to some embodiments. A default starting point 410 includes recent activity of the user within the datacenter. Accordingly, display 410 may be a default display when the user enters the application 144 to access the datacenter directly, rather than responding to a specific notification (e.g., from institutional client 120). Accordingly, the user may enter an input gesture 401 (e.g., a tap) to select an item in the display and navigate into a lower hierarchy layer of the database architecture. The display is split by moving the bottom bar upward 402, and including the title of the lower hierarchy layer selection in the bottom bar. Each time the user invokes a child object in a lower hierarchy layer, a new layer is added to the application 144. That layer enters the application 144 from the bottom of the screen and transitions to the top (Stacking on top of the previous parent). There is no limit to the number of layers a user can invoke. In some embodiments, application 144 is designed such that four (4) hierarchical layers or more may be listed and maintained at the user's reach. In some embodiments, less than four (4) hierarchical layers may be desirable, considering the availability of screen display space.

FIG. 4B illustrates navigation feature 400 for accessing deeper items in the datacenter hierarchy, such as selecting a course from a course list in an datacenter associated with academic records, according to some embodiments. A first input gesture 401 in screen 430 by the user selects an item to navigate down to a lower hierarchy layer. Screen 440 shows the bottom bar in an upward motion 402 revealing the contents if the child item in the bottom portion of the screen. Accordingly, the title of the item selected in the lower hierarchy layer (child item) is displayed in the bottom bar as it moves up.

FIG. 4C illustrates navigation feature 400 for accessing deeper items in the datacenter hierarchy, such as a document list within a course selected from the course list, according to some embodiments. Screen 440 has a top bar with the name of the child item select by the user, and a display of the contents of the child item. The user applies input gesture 401 again, to select a second item (grandchild item) and navigate further down the hierarchy layers in the datacenter architecture. As in display 440, display 450 includes the bottom bar in upward motion 402 revealing the contents of the grandchild item, with the title of the grandchild item visible in the bar.

FIG. 4D illustrates navigation feature 400 for accessing deeper items in the datacenter hierarchy, such as a document selected from the document list in the course, according to some embodiments. Accordingly, display 450 provides the contents of the grandchild item, with the grandchild item title visible on the top bar of display 450.

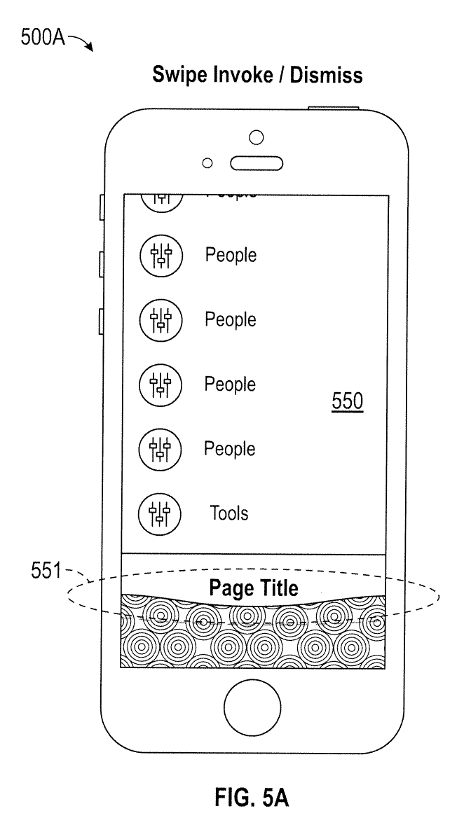

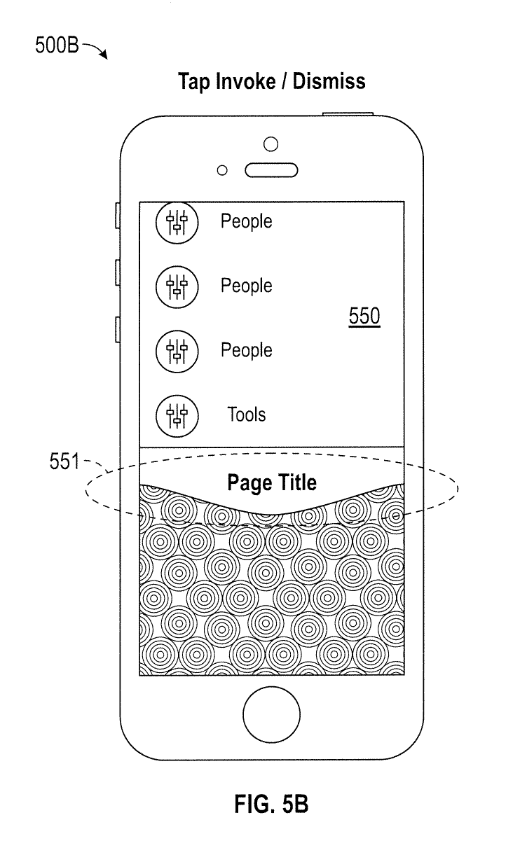

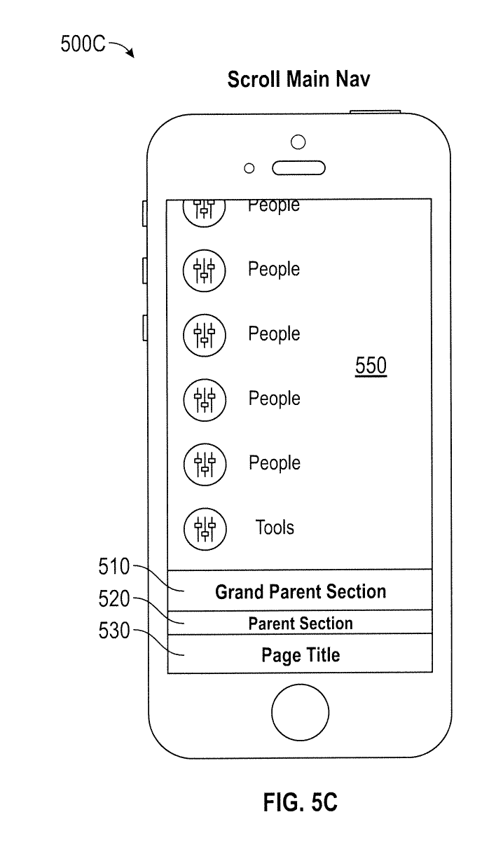

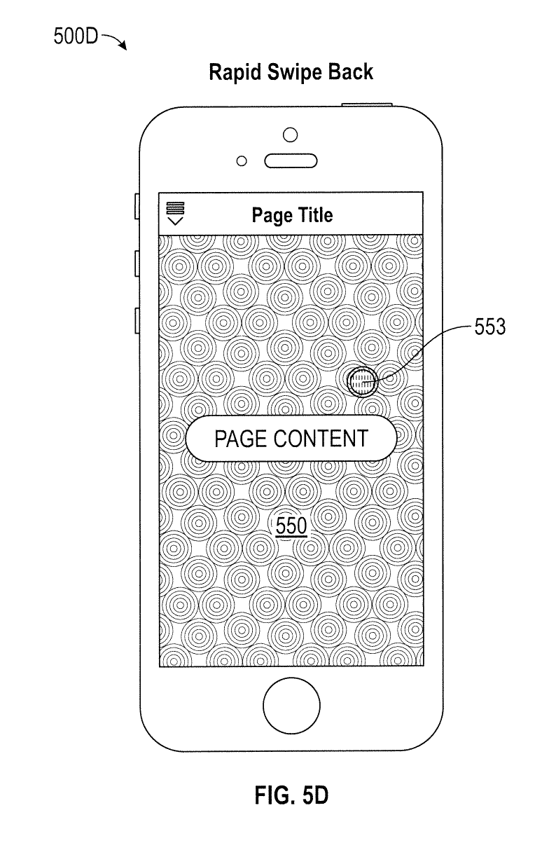

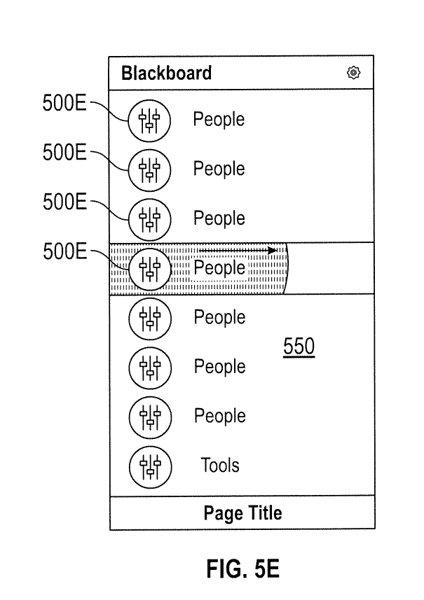

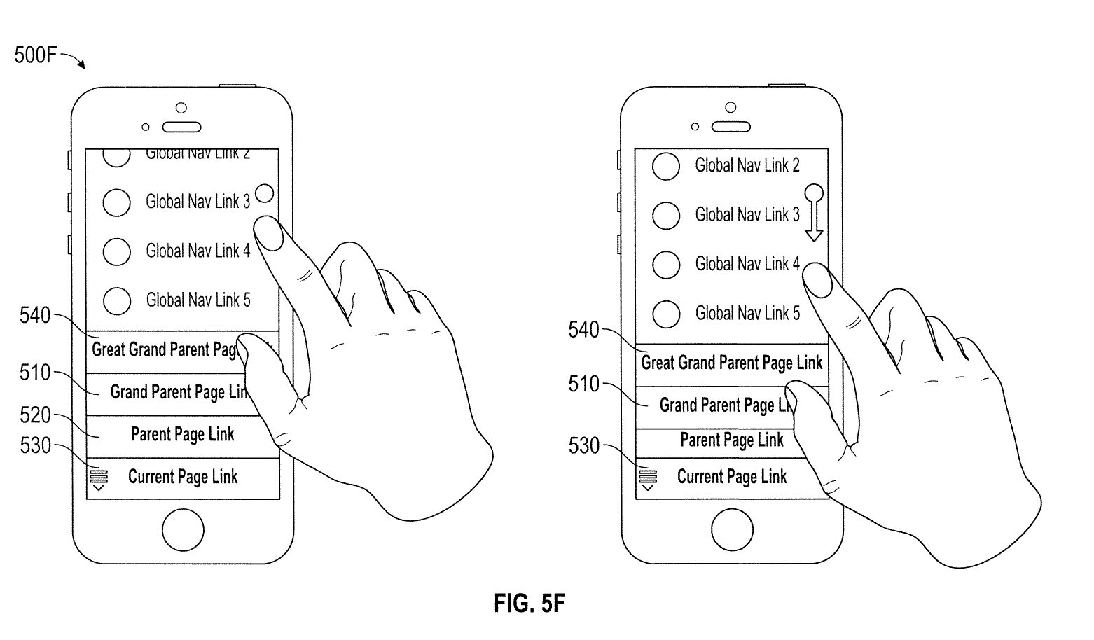

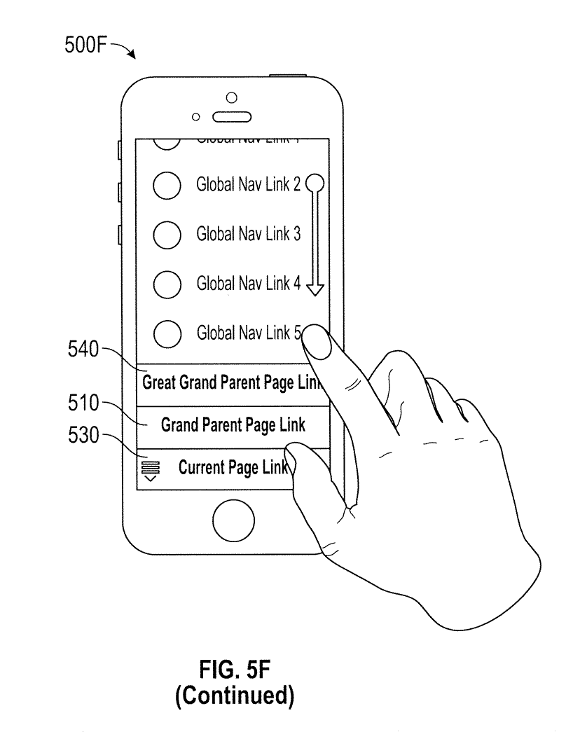

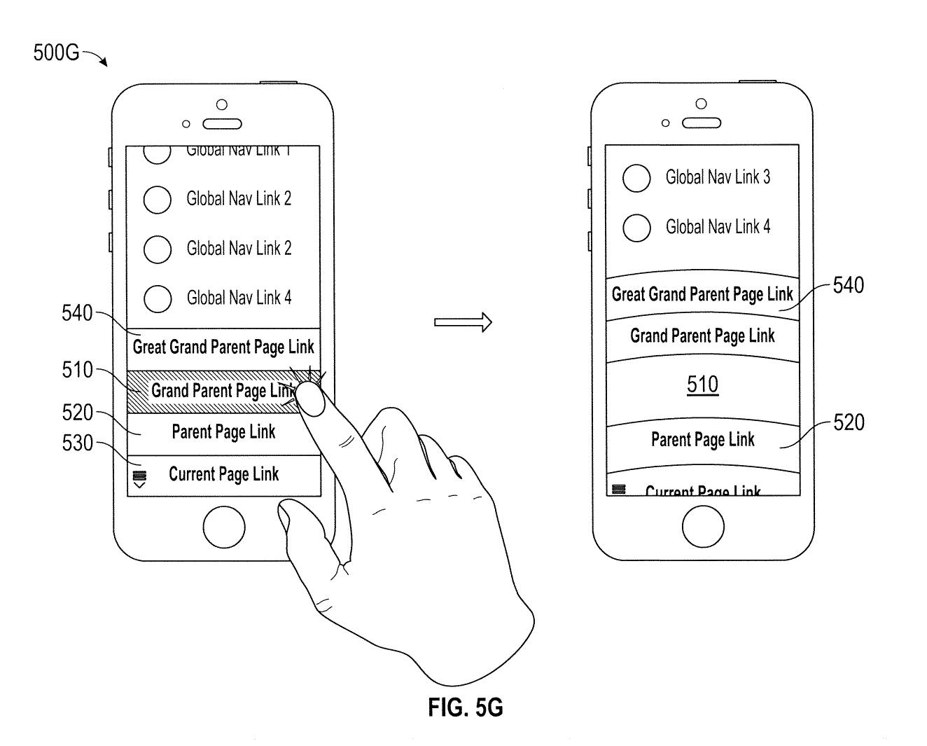

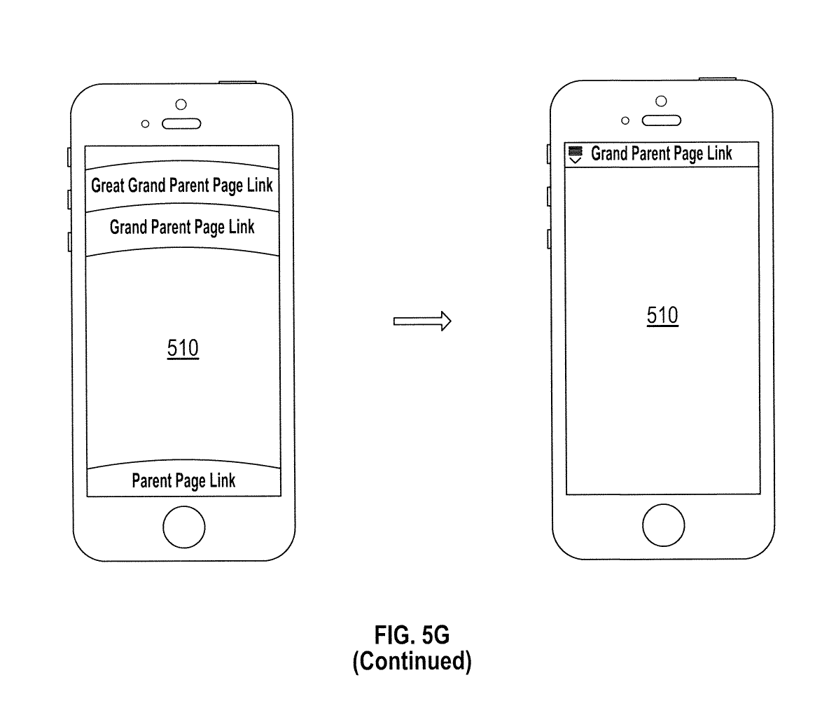

FIG. 5A illustrates a swipe invoke and dismiss motion definition 500A for navigating through the datacenter hierarchy, according to some embodiments. A panel 550 at a given hierarchy layer in the datacenter may include a bottom bar corresponding to a document in a different hierarchy layer of the datacenter. Swipe invoke and dismiss motion 500A illustrates a visual effect 551 by which graphic user interface 246 indicates the user that the requested page is being loaded (/or unloaded) for view (or out of view). In some embodiments, visual effect 551 is transient and stops when the page is loaded in full view (in which the page title is shown as a top bar) or completely out of view (in which the page title is shown as a bottom bar, for further access).

FIG. 5B illustrates a tap invoke and dismiss motion definition 500B for navigating through the datacenter hierarchy, according to some embodiments. Tap invoke and dismiss motion 500B has a similar effect as swipe invoke and dismiss motion 500A, except that a tap gesture replaces a swipe gesture.

FIG. 5C illustrates a scroll main layer motion definition 500C for navigating through the datacenter hierarchy, according to some embodiments. By scrolling down on a base page, a user may prompt the graphic user interface to display at the bottom of the screen a plurality of bars representing the history of hierarchy layer access by the user. Accordingly, a bar for a grandparent item 510, a bar for a parent item 520, and a bar for a child item 530 are displayed. A different reference to the same hierarchy level structure in the database architecture may be ‘item’ 510, ‘child’ item 520, and ‘grandchild’ item 530, without loss of generality. Accordingly, the user is able to access any one of the three different hierarchy layers in items 510, 520, 530, without the need for linearly retrace the steps to reach each of them. This feature of graphical user interface 246 is especially convenient when a large number of input gestures has been entered by the user. Also, feature 500C for navigating through the datacenter hierarchy is desirable to reduce the number of input gestures that a user applies to access certain layer of the database architecture.

FIG. 5D illustrates a rapid swipe back definition 500D for navigating through the datacenter hierarchy, according to some embodiments. When the user has reached the top of a page 550, a rapid swipe back motion 500D starting from any point 553 in the display momentarily reveals the contents of the layer underneath the current page on display.

FIG. 5E illustrates a plurality of navigation buttons 500E for navigating through the datacenter hierarchy, according to some embodiments. When the user taps on any one of navigation buttons 500E, graphical user interface 246 provides a visual effect to indicate the user which button was selected. The visual effect may include a horizontal bar overlapping and highlighting the selected button that grows from left to right in panel 550.

FIG. 5F illustrates a dynamic view of a scroll main layer motion definition 500F for navigating through a datacenter hierarchy, according to some embodiments. In addition to grandparent item 510, a parent item 520, child item 530, and a great grandparent item 540 are also displayed. Accordingly, motion 500F indicates how each of items 510, 520, 530, and 540 are being displayed in the lower part of the screen as a slow downward swipe motion of a pointing finger moves the display of the main layer down. In some embodiments as illustrated in FIG. 5F the current item link (‘child item’) 530 is maintained accessible to the user throughout motion definition 500F.

FIG. 5G illustrates a dynamic view of an asymmetrical navigation 500G through a datacenter hierarchy, according to some embodiments. In addition to grandparent item 510, a parent item 520, child item 530, a great grandparent item 540 is also displayed. Accordingly, by tapping on any of links 510, 520, 530, or 540, the user may access the designated page regardless of its place in the hierarchy. As the selected item is displayed on the screen, links for items 520, 530 and 540 are still on display. After a pre-selected period of time, or after a user gesture such as tapping on the field of item 510, the links for items 520, 530, and 540 may collapse into a single bar (e.g., at the top of the display). The user may still access items 520, 530, and 540 by tapping on the small icon shown to the left of the collapsed bar, which will then expand down to show the links for items 520, 530, and 540.

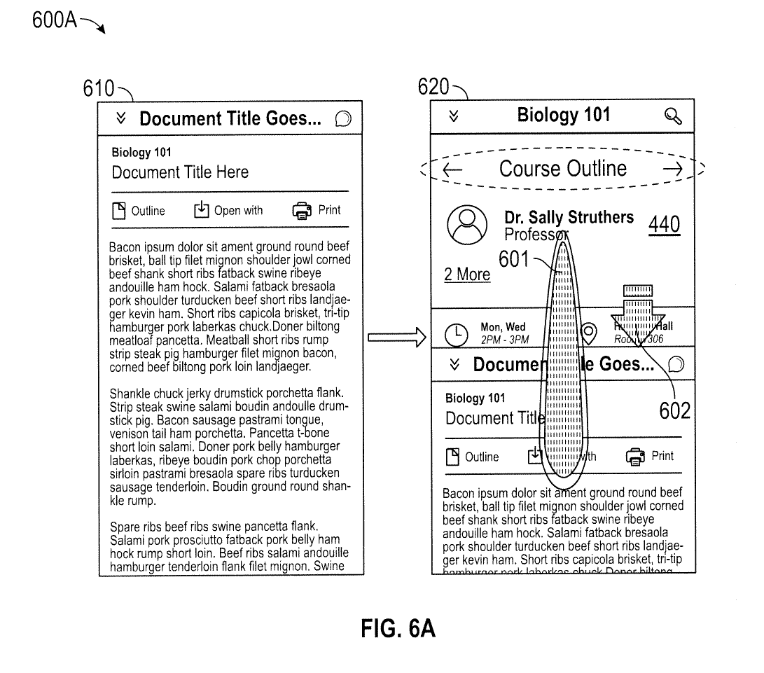

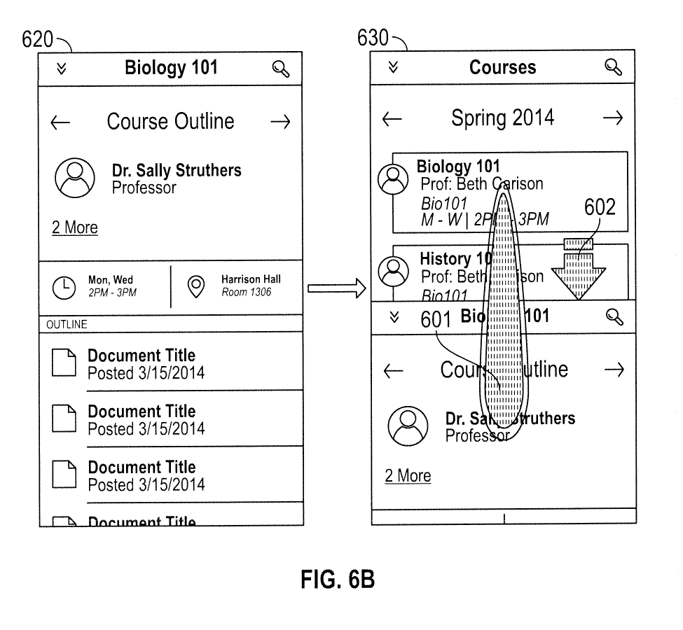

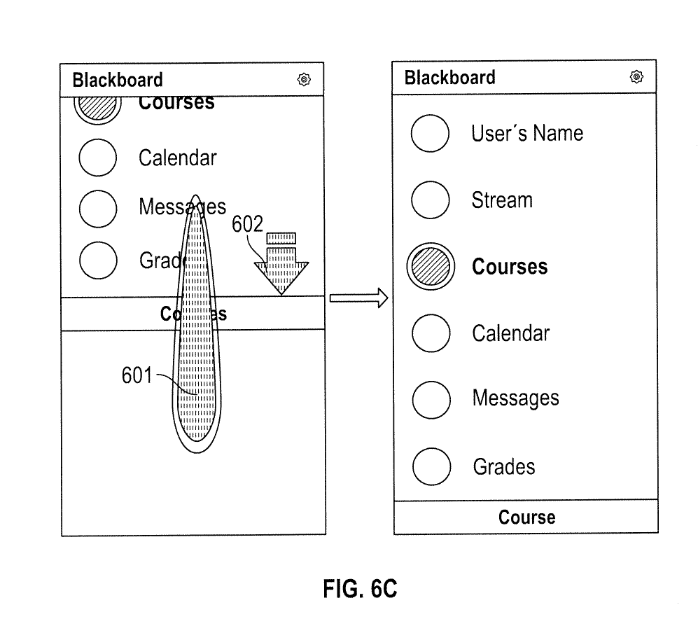

FIG. 6A illustrates a linear exit and rapid swipe tool 600A for returning to higher hierarchy layers in a datacenter hierarchy such as leaving a document 610 to access a document list 620 within a course, according to some embodiments. Accordingly, the user may apply a rapid swipe in a vertical direction 601 (e.g., downward), to exit document 610 (e.g., including the content of a course assignment). The fast swipe 601 generates a displacement of the screen in a direction 602 to display the higher hierarchy layer 620. Fast swipe 601 may be as fast swipe 500D, discussed above.

Users can dismiss layers with a rapid swipe 601 on the screen. Each time the user rapidly swipes from top to bottom, the visible layer is dismissed. Pages where the user has scrolled to the bottom of a long list/document, the initial rapid swipe will bring them to the top of the page. Upon reaching the top of the page, the page itself should bounce down from the top of the screen, momentarily revealing the layer underneath. In some embodiments, rapid swipe 601 produces the effect illustrated in FIG. 6A when the user has reached the top of a current panel. For example, when the user is a the top of document 610, a further rapid swipe down 601 would bring up the upper hierarchy layers of navigation as illustrated in panel 620.

FIG. 6B illustrates a linear exit and rapid swipe tool for returning to higher layers in a datacenter hierarchy such as leaving the document list to access a course list, according to some embodiments. Accordingly, a display showing panel 620 in a lower hierarchy layer may be switched to a display showing panel 630 in a higher hierarchy layer 630 when a rapid swipe down motion 601 is applied to reveal the contents of the higher hierarchy layer 630 as the top bar in panel 620 is displaced down 602 to the bottom of the display.

FIG. 6C illustrates a linear exit and rapid swipe tool for returning to higher layers in a datacenter hierarchy such as leaving the course list to access the base location, according to some embodiments. Accordingly, FIG. 6C includes rapid swipe down motion 601 to produce a downward motion 602 of the title bar of the current panel in the display. In FIG. 6C, rapid swipe down motion 601 is applied to a base layer. A base layer is the initial layer started by the user in a given session of application 144. In some embodiments, the base layer may be the highest hierarchy layer accessed by the user during a given session of application 144. Accordingly, in some embodiments rapidly swiping down on a base layer will display the menu or the highest hierarchy layer in the datacenter with the most recent base layer accessible with a title bar at the bottom of the screen.

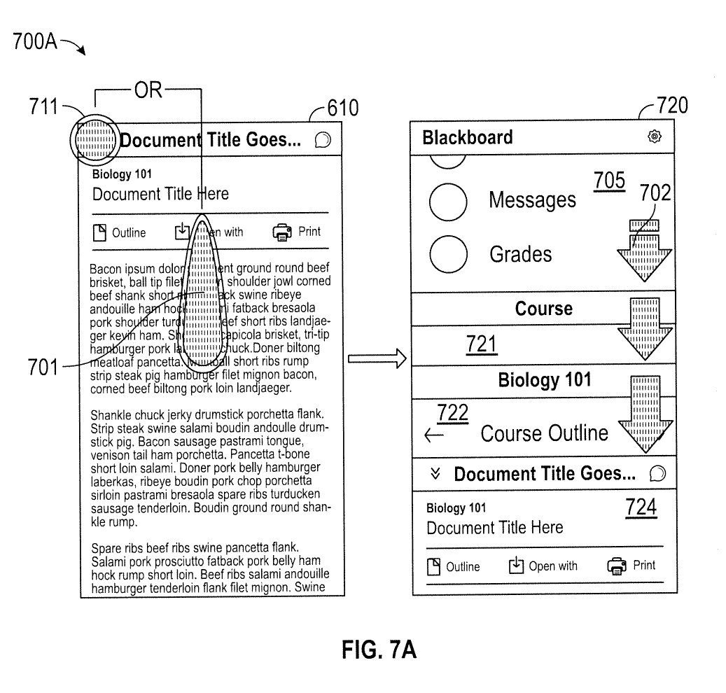

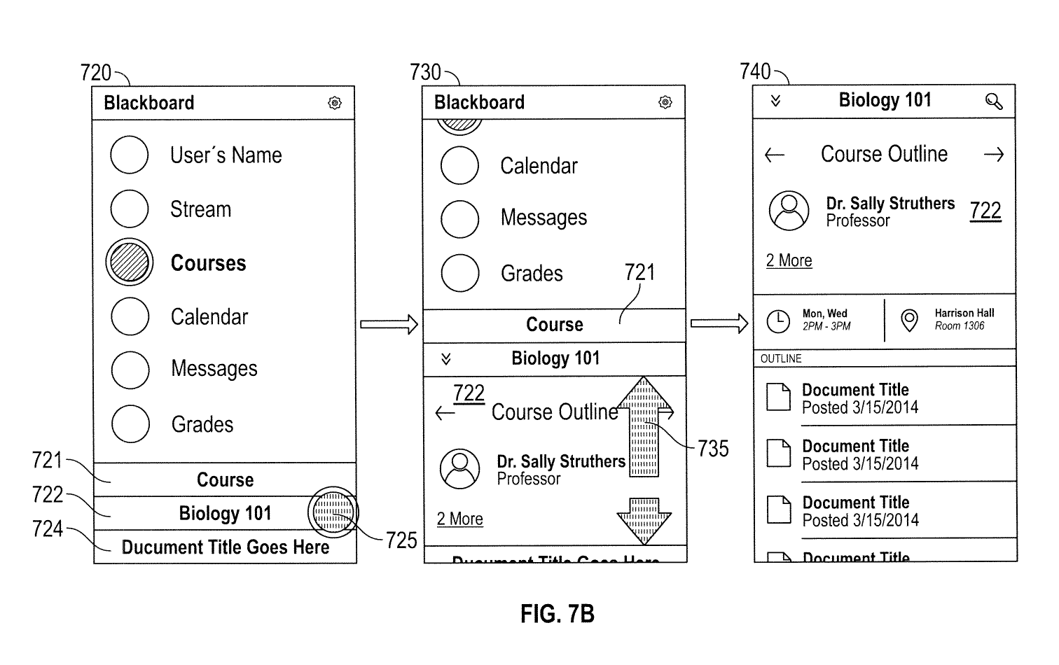

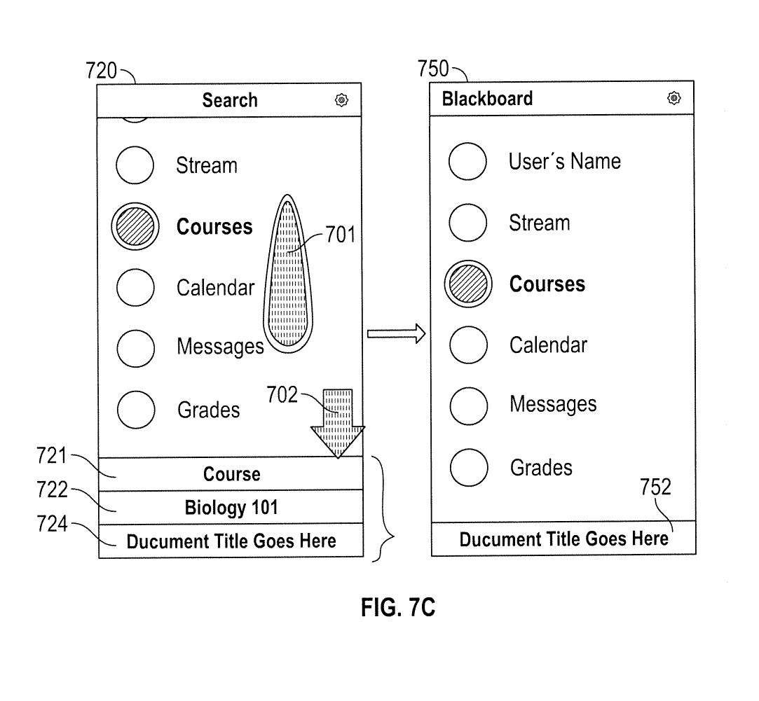

FIG. 7A illustrates an asymmetric exit tool 700A including a slow swipe and a menu button to navigate away from a deep layer in a datacenter hierarchy such as leaving a document from within a course, according to some embodiments.

The menu button 711 appears at the top of every layered page in the system (except for instances where the user is in a creation state. Tapping the menu button will invoke the menu. This action is the same as performing a slow swipe down. When either action is performed (pressing the menu or slow swipe), the “hierarchical history” of navigation (most recent base page to highest layer) is displayed at the bottom of the screen. The bottom of the menu 705 appears above the highest layer.

FIG. 7A shows the ability to pull down menu button 711 or apply a slow vertical swipe 701 (e.g., downward) from document 610 and have access to different generations of hierarchy levels 721, 722, and 724, as shown in panel 720 with a downward movement 702 of the display. The user may directly access either one of hierarchy layers 721, 722, and 724 simply by tapping on to them (e.g., with a double tap). This type of asymmetrical navigation allows a user to access any hierarchy layer in the datacenter architecture without having to linearly retrace the navigation steps leading to a current hierarchy layer. Users can asymmetrically navigate the layers of the application 144 by pressing the menu button, or slow swiping down on the screen. When either action is performed, the “hierarchical history” of navigation (most recent base page to highest hierarchy layer) is displayed at the bottom of the screen, such as hierarchy layers 721, 722, and 724. The bottom of the menu appears above the highest layer.

FIG. 7B illustrates an asymmetric exit tool including a slow swipe and a menu button to navigate away from a deep layer in a datacenter hierarchy such as leaving a document list into a course contents list, according to some embodiments. Accordingly, FIG. 7B includes invoking a previous hierarchy layer by applying a tap gesture 725 on the title bar of the item in the previous hierarchy layer at the bottom of the display. Users can invoke any hierarchy layer in the visible stack by tapping on it. Tapping on a specific item belonging to a hierarchy layer will navigate the user to the selected item. Without limitation, the previous hierarchy layer may be higher or lower than the current hierarchy layer. Tapping on a new base item (i.e. moving from ‘courses’ to ‘stream’) will clear the user's navigation history.

FIG. 7C illustrates an asymmetric exit tool including a slow swipe and a menu button to navigate away from a deep layer in a datacenter hierarchy such as scrolling down from a list of items in a base location, according to some embodiments. Some embodiments include a gesture for scrolling the menu down. Depending on the visual size of the main menu, it is possible for the menu to be cut off when there are more than 3 or 4 historical elements stacked at the bottom of the page during an asymmetrical exit, as illustrated in FIGS. 7A-7B. When the user scrolls the menu down, the layered list of items 721, 722, and 724 will condense as a stack 752. In some embodiments, stack 752 keeps the highest hierarchy layer among items 721, 722, and 724 visible at the bottom of the page. The menu will appear to scroll behind the stacked layers.

Some embodiments also include scrolling the menu up. In such event, the condensed stack of layers 752 will expand back to layers 721, 722, and 724. This allows the user to visually remove the history (to navigate the menu) without actually removing their navigation history.

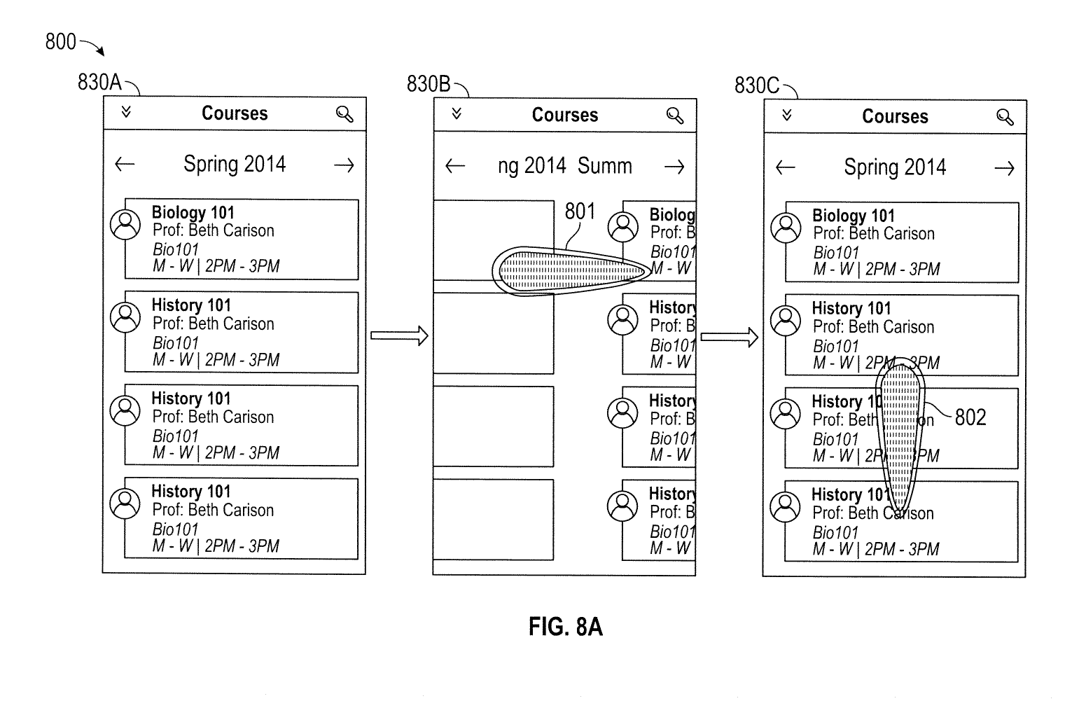

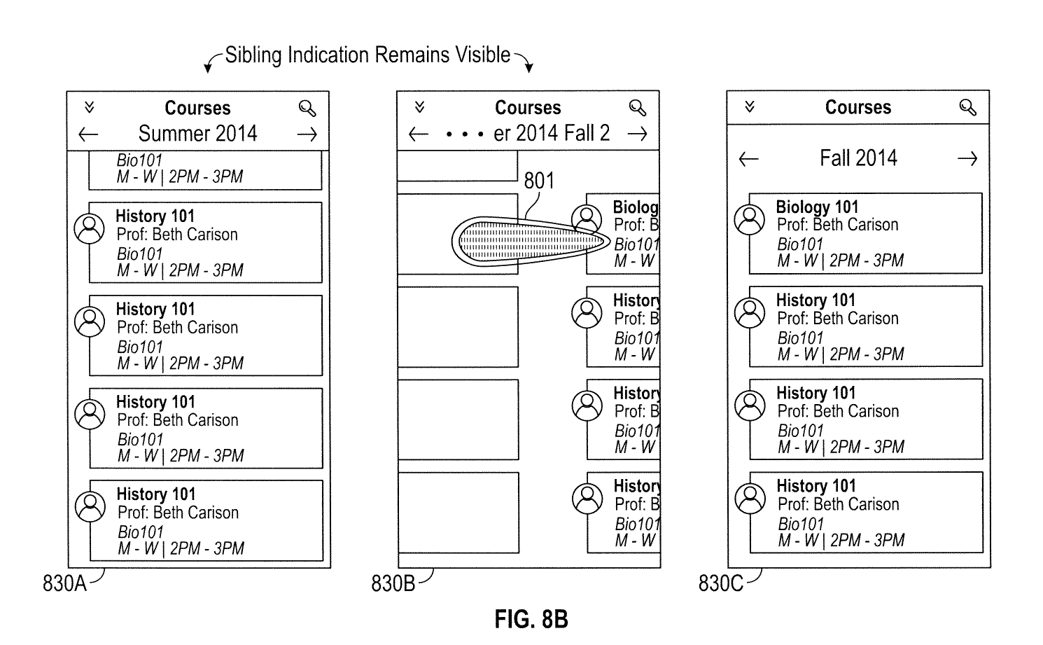

FIG. 8A illustrates a navigation tool between sibling items in a datacenter architecture such as accessing course lists associated with different semesters, according to some embodiments. Sibling items in a datacenter architecture are items sharing the same hierarchy layer. For example, in a datacenter associated with an academic institution, assignments associated with a course through different semesters may be siblings sharing the same hierarchy layer. Just as siblings are part of the same hierarchy layer, certain experiences on application 144 have pages that are related that must stand together, but maintain some form of independence. Siblings are related pages that are accessed as a group. Sibling can be used to organize similar types of information over time—like a course timeline including different semesters throughout the year—or multivariate content like the course page. Siblings allow users to perform a single search across all of the related pages and content types.

Accordingly, embodiments of the present disclosure provide features for navigating through sibling pages. In some embodiments, sibling pages are organized on a left—right axis. Each sibling item maintains its own default entry point. As users swipe left and right between sibling pages, the title of the pages is displayed. If the user scrolls up and down a long sibling page, the title is pushed into the title bar, allowing users to keep track of current location within the datacenter architecture. Users can swipe left and right at any moment to move between sibling pages. Users can also tap the arrows that appear next to the title of the sibling page. Tapping an arrow will move their point of focus to the corresponding sibling page (left or right).

FIG. 8B illustrates a navigation tool between sibling items in a datacenter hierarchy where the user scrolls a long sibling page and the title of the page is pushed into the header bar, according to some embodiments.

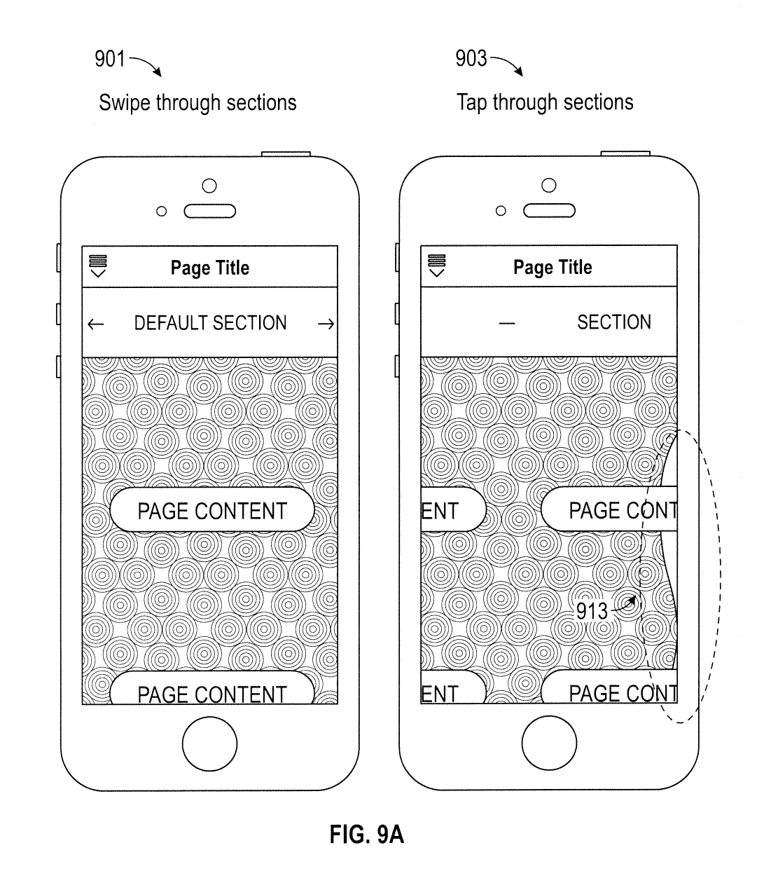

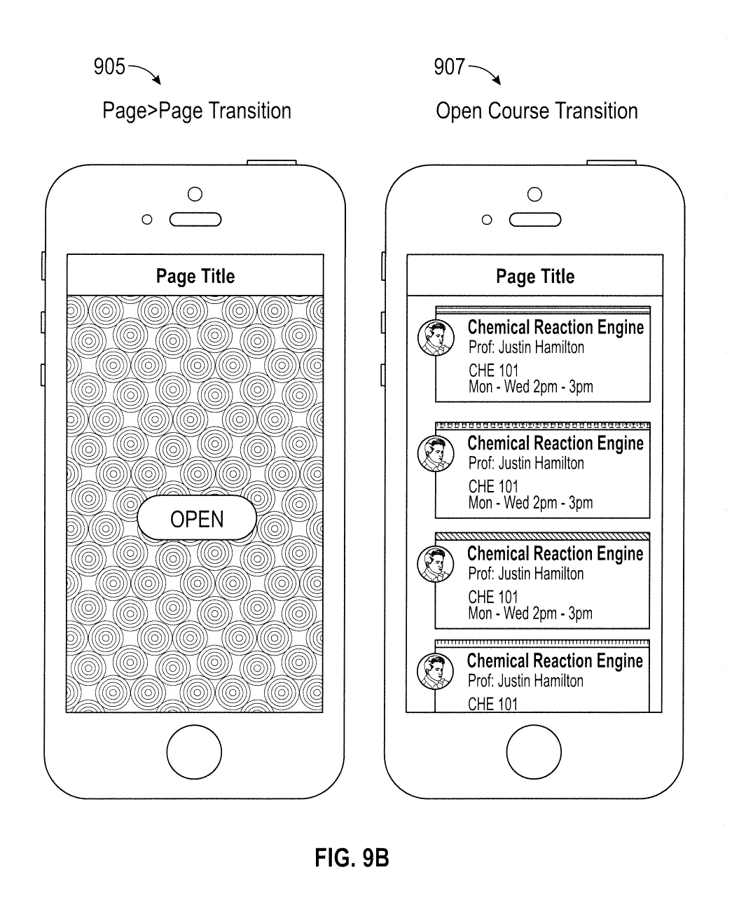

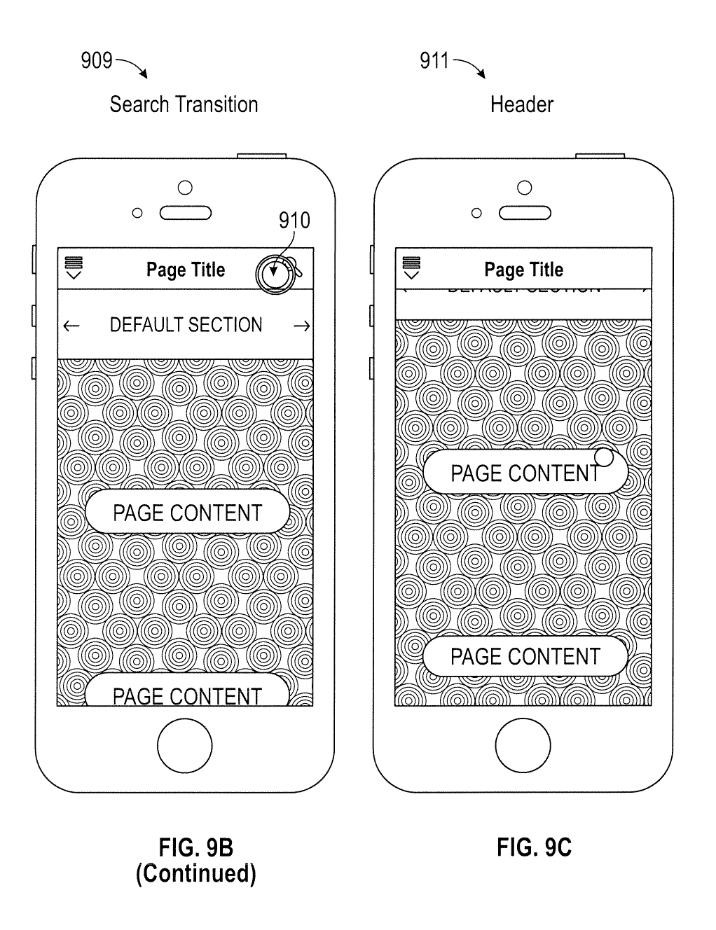

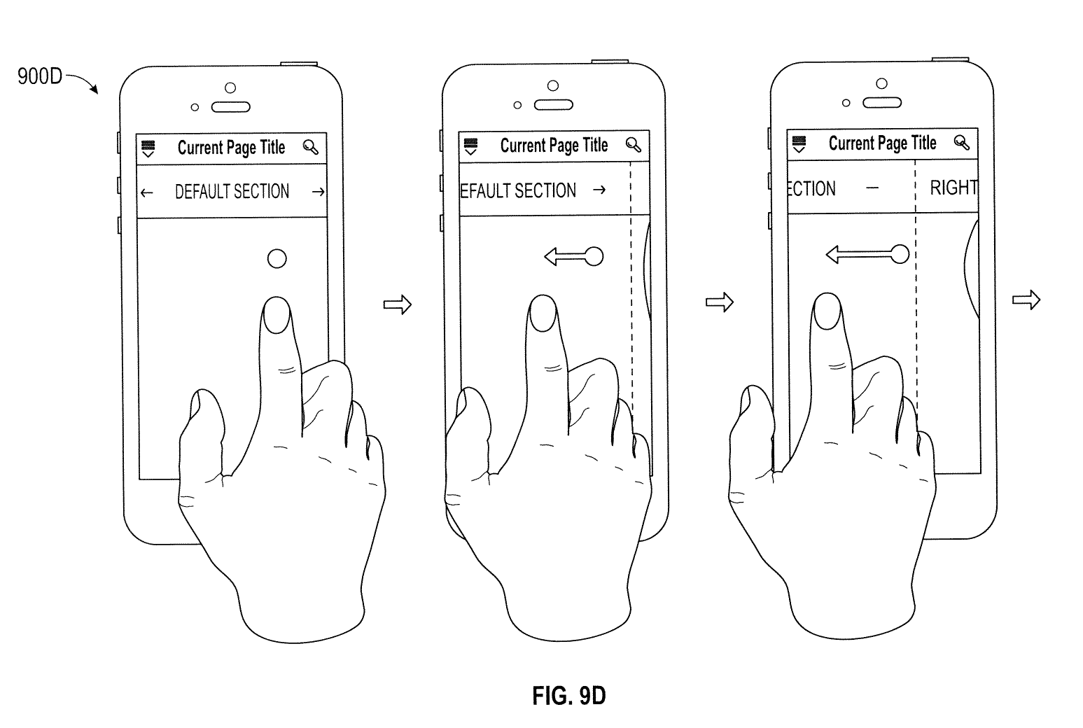

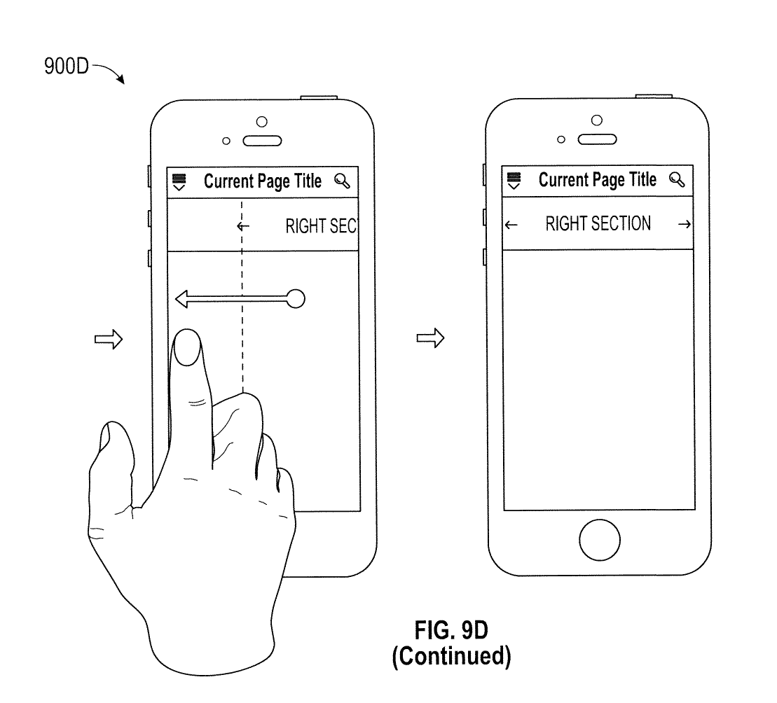

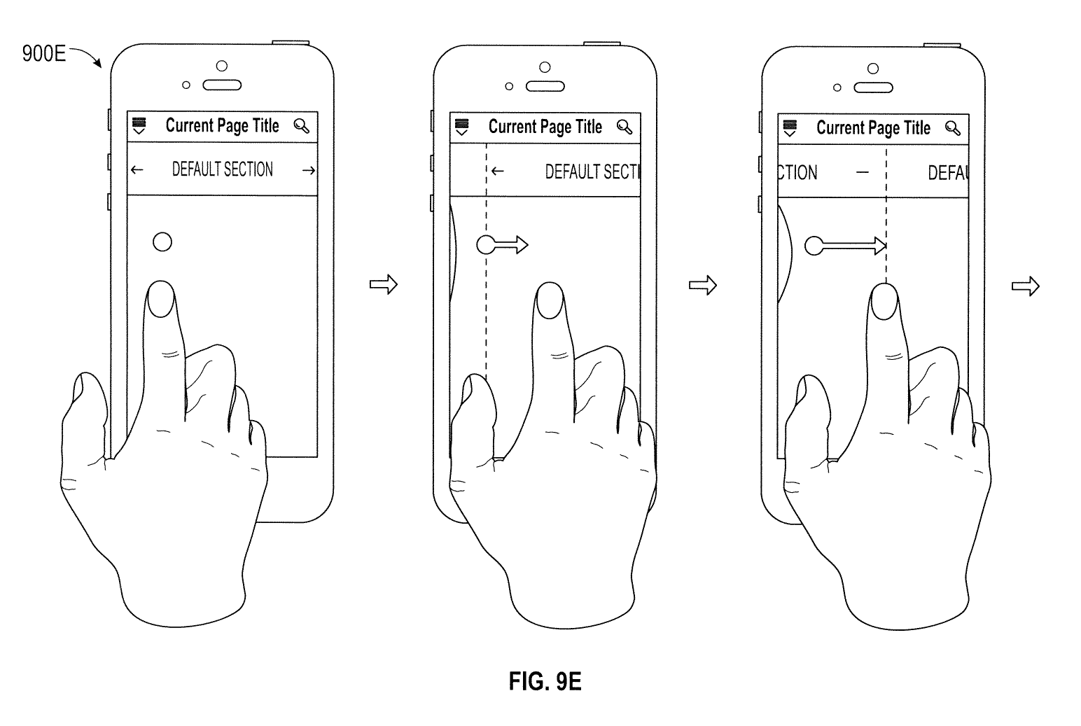

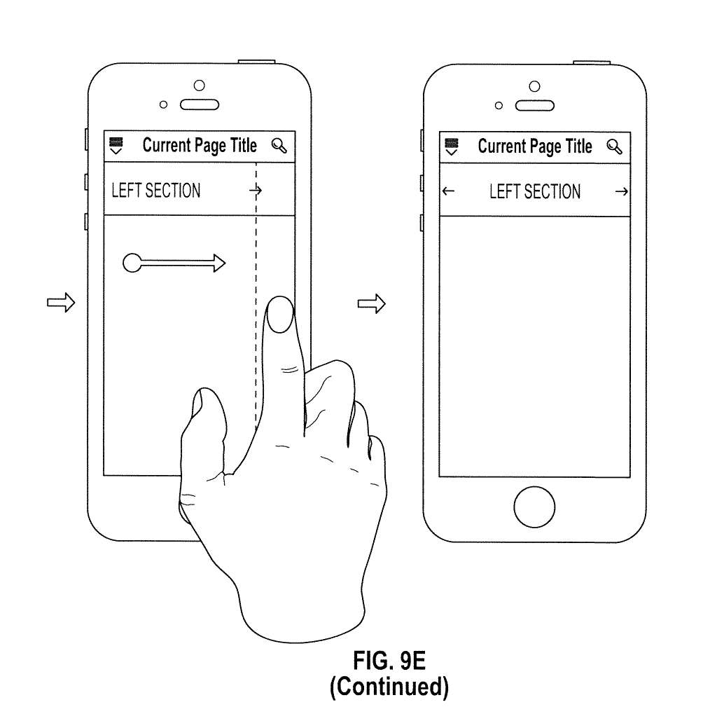

FIG. 9A illustrates a navigation tool between sibling items in a datacenter hierarchy including a ‘swipe through sections’ gesture 901 and a ‘tap through sections’ gesture 903, according to some embodiments. Gesture 903 includes a visual effect 913 which provides a transient wavy edge to the screen while the new section is being provided on the display. As in the case of visual effect 551, visual effect 913 provides an indication for the user that the requested action is being processed, or has already been completed. Accordingly, the absence of visual effect 913 may indicate the user that the input gesture was not successful or needs to be repeated. One of ordinary skill recognizes that embodiments consistent with the present disclosure may include visual effects of the type of visual effect 913 (or visual effect 551) together with any and all of the input gestures disclosed herein.

FIG. 9B illustrates a navigation tool between sibling items in a datacenter hierarchy including a ‘page to page’ transition 905, an ‘open course’ transition 907, and a ‘search transition’ 909, according to some embodiments. Search transition 909 is prompted by a tap 910 on the header bar.

FIG. 9C illustrates a navigation tool between sibling items in a datacenter hierarchy including a ‘header’ transition 911, according to some embodiments.

FIG. 9D illustrates a dynamic view of a swipe through sibling items 900D to view a right section in a datacenter hierarchy, according to some embodiments. A sub-header bar indicates the name of the current sibling document (e.g., ‘Default Section’) within the hierarchy layer indicated by the header title (e.g., ‘Current Page Title’). Swiping the finger to the left, as indicated, moves the ‘Right Section’ sibling into view. The dynamic view of FIG. 9D indicates a visual effect of a bending of the display screen on the right hand margin of the display to give the user the sensation of motion in the left direction.

FIG. 9E illustrates a dynamic view of a swipe through sibling items 900E to view a left section in a datacenter hierarchy, according to some embodiments. A sub-header bar indicates the name of the current sibling document (e.g., ‘Default Section’) within the hierarchy layer indicated by the header title (e.g., ‘Current Page Title’). Swiping the finger to the right, as indicated, moves the ‘Left Section’ sibling into view. The dynamic view of FIG. 9D indicates a visual effect of a bending of the display screen on the left hand margin of the display, to give the user the sensation of motion in the right direction.

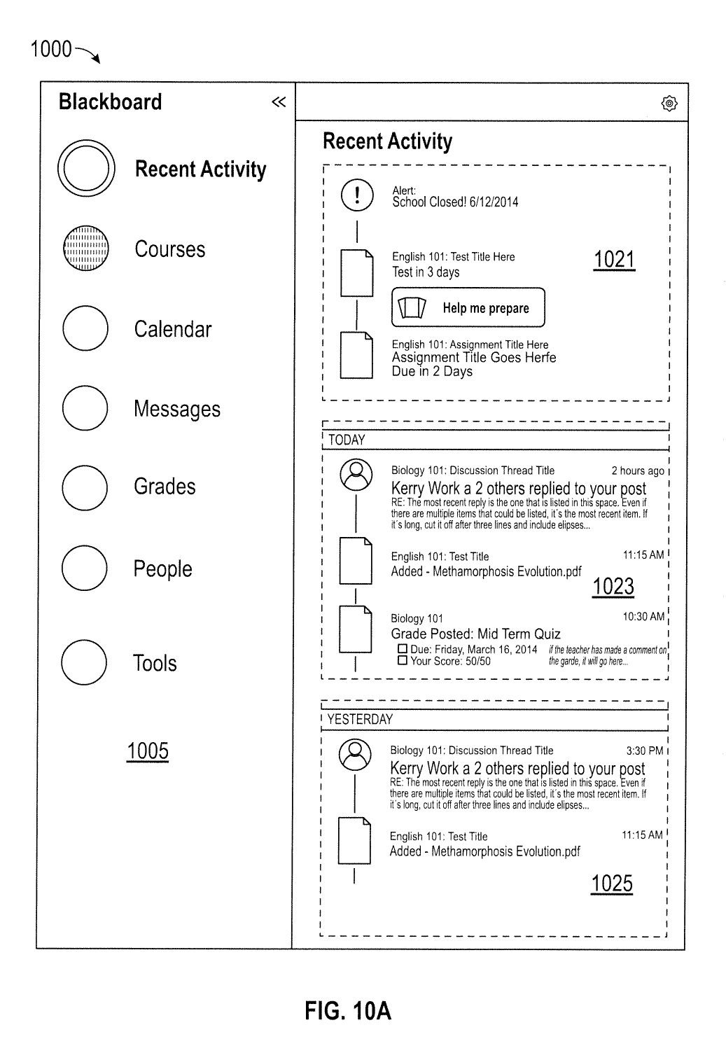

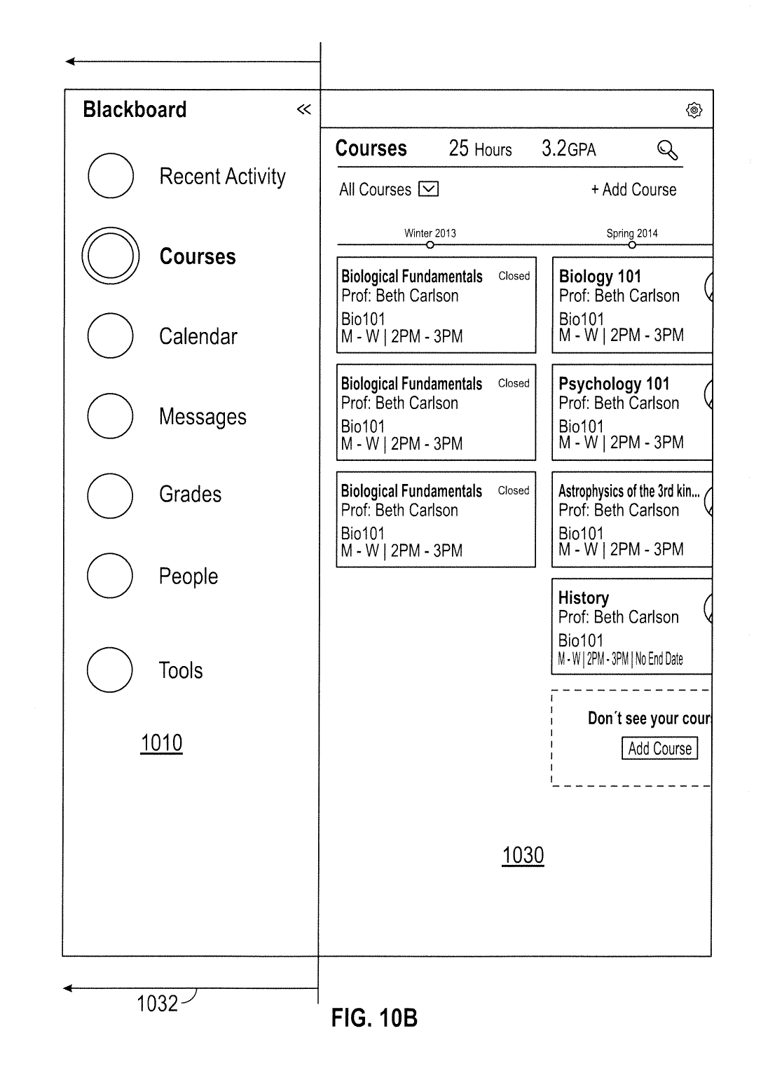

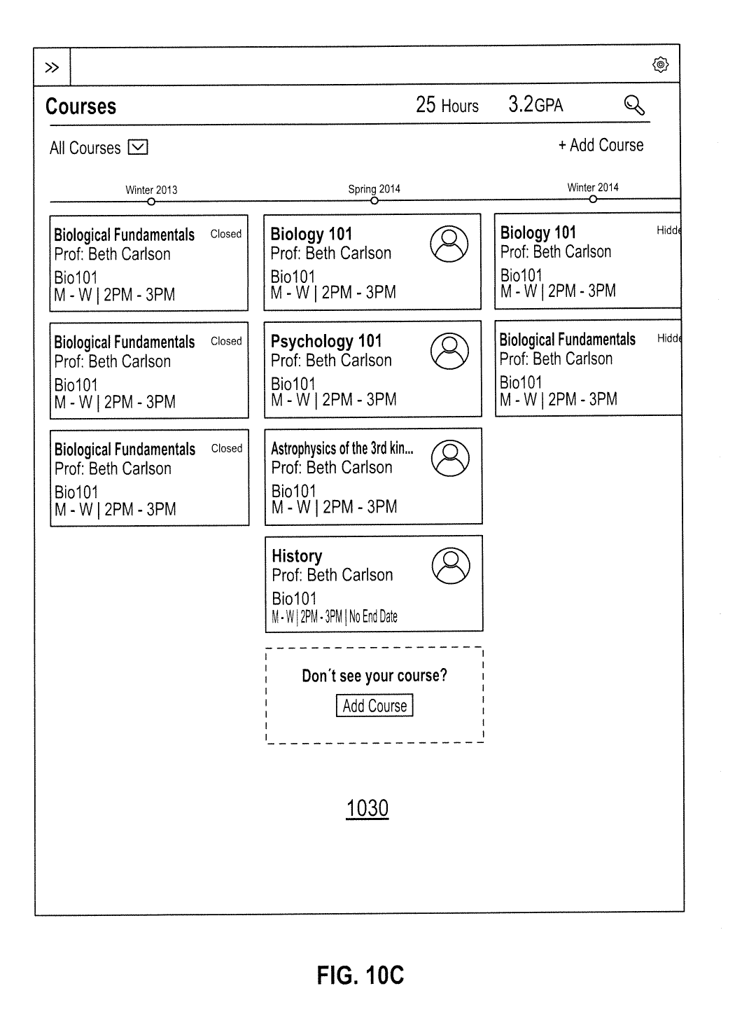

FIG. 10A illustrates a tablet navigation tool 1000 for accessing deeper items in the datacenter hierarchy starting at the base location, according to some embodiments. Accordingly, FIG. 10A illustrates a portrait configuration where the user has selected a menu button to display a menu tray 1005 (cf. display 311B). In some embodiments, tool 1000 may be included in a graphical user interface configured for an IOS® (APPLE) or an ANDROID® (GOOGLE) operating system. On devices operating a WINMO® operating system (MICROSOFT) a single column of icons may be permanently displayed (cf. display 301B) such that tapping on the menu icons slides the menu to full width, revealing text descriptors on all icons as shown on menu 1005. On operating system platforms supported in embodiments consistent with the present disclosure, a landscape orientation affords a fixed placement of menu tray 1005 (cf. display 321B).

Navigation tool 1000 may include a menu tray 10005 on a portion of the screen to the left of a content display. The content display may include a ‘recent activity’ page, for example, when the user has started application 144 without responding to a notification or alert. The content display may include, without limitation an alerts section, 1021, a ‘today’ activity section 1023, and a ‘yesterday’ activity section 1025.

FIG. 10B illustrates tablet navigation tool 1000 for accessing deeper items in the datacenter hierarchy including a show/hide tool for the menu, according to some embodiments. Accordingly, the user can either swipe from the left edge of the device or tap on the menu button on the top left of the header bar to invoke/dismiss menu tray 1005.

FIG. 10C illustrates a tablet navigation tool for accessing deeper items in the datacenter hierarchy hiding the menu, according to some embodiments. When the user holds the device in portrait orientation, menu tray 1005 is hidden by default (cf. display 301C). When a base selection is made, the menu hides itself once again by sliding to the left.

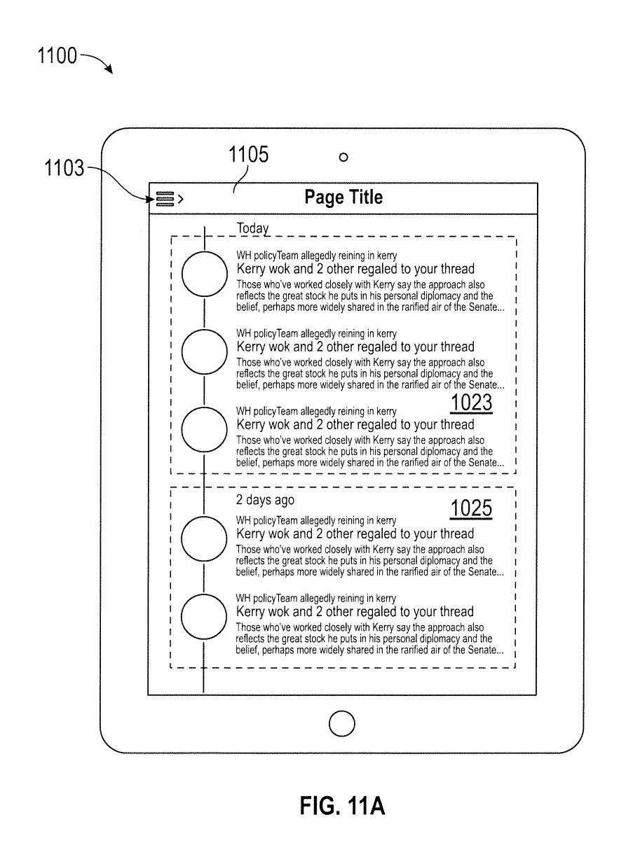

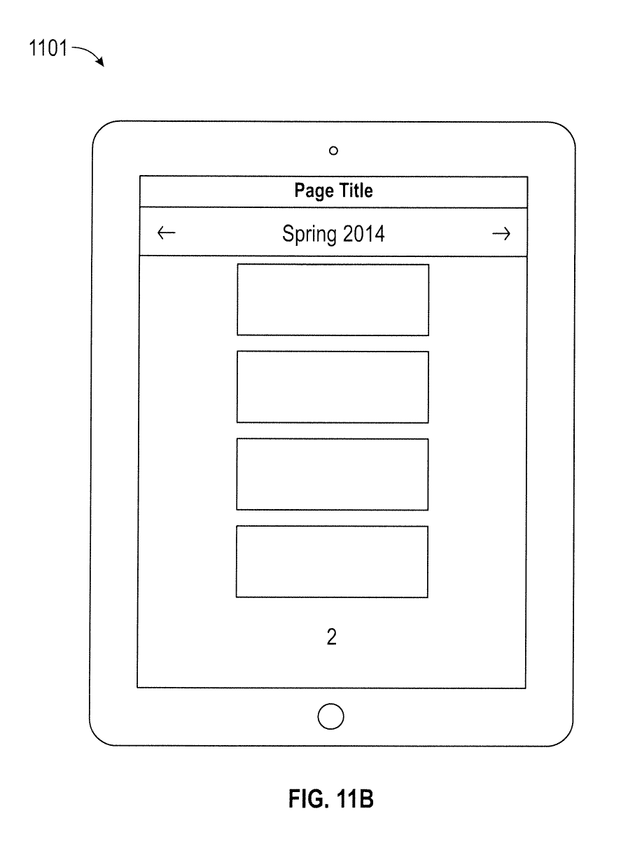

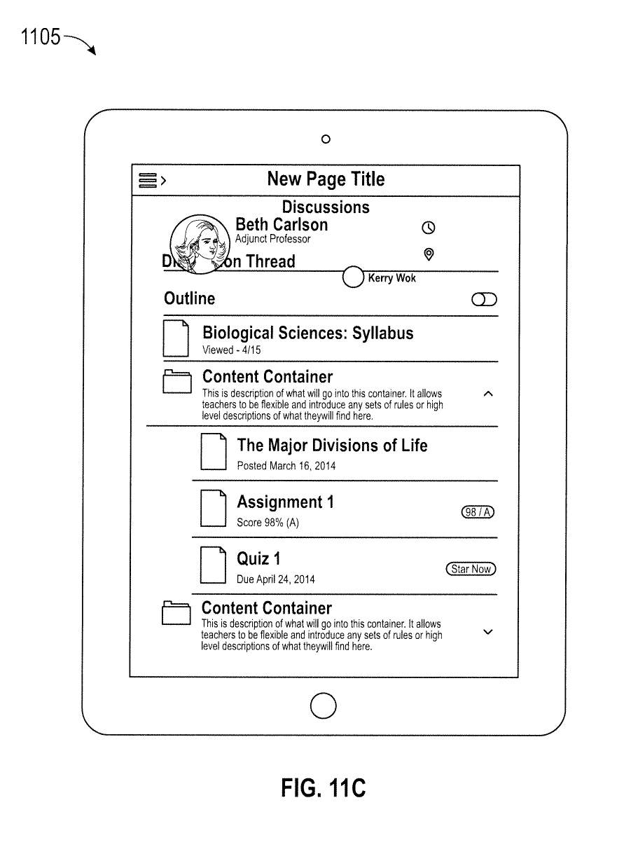

FIG. 11A illustrates an invoke/dismiss motion 1100 for navigating through a datacenter hierarchy with a tablet device, according to some embodiments. In invoke/dismiss motion 1100, a menu button 1103 and a title bar 1105 may be as described in detail above (cf. menu button 303 and title bar 305). In some embodiments, application 144 provides a default starting point. If the user is not entering application 144 by swiping on a notification, application 144 provides recent activity page as a default starting point (cf. FIG. 10A). In this flow, the user has opened the menu and selected courses.

When a user invokes a child object, a new hierarchy layer is added at the bottom of the display of application 144. The new hierarchy layer enters application 144 from the right side of the screen and sits above the previous hierarchy layer (leaving a small space to the left where the parent content can still be seen). There is no limit to the number of layers a user can invoke. In some embodiments, application 144 may include up to four (4) hierarchy layers on display (or more, according to the display availability).

FIG. 11B illustrates a swipe/tap through sections motion 1101 for navigating through a datacenter hierarchy with a tablet device, according to some embodiments. In that regard, motion 1101 may be as swipe/tap through sections motion 901, to navigate between sibling items on the same hierarchy layer.

FIG. 11C illustrates a page to page transition 1105 in a tablet navigation through a datacenter hierarchy, according to some embodiment. In that regard, motion 1105 may be as page to page transition motion 905 to navigate between sibling items in the same hierarchy layer.

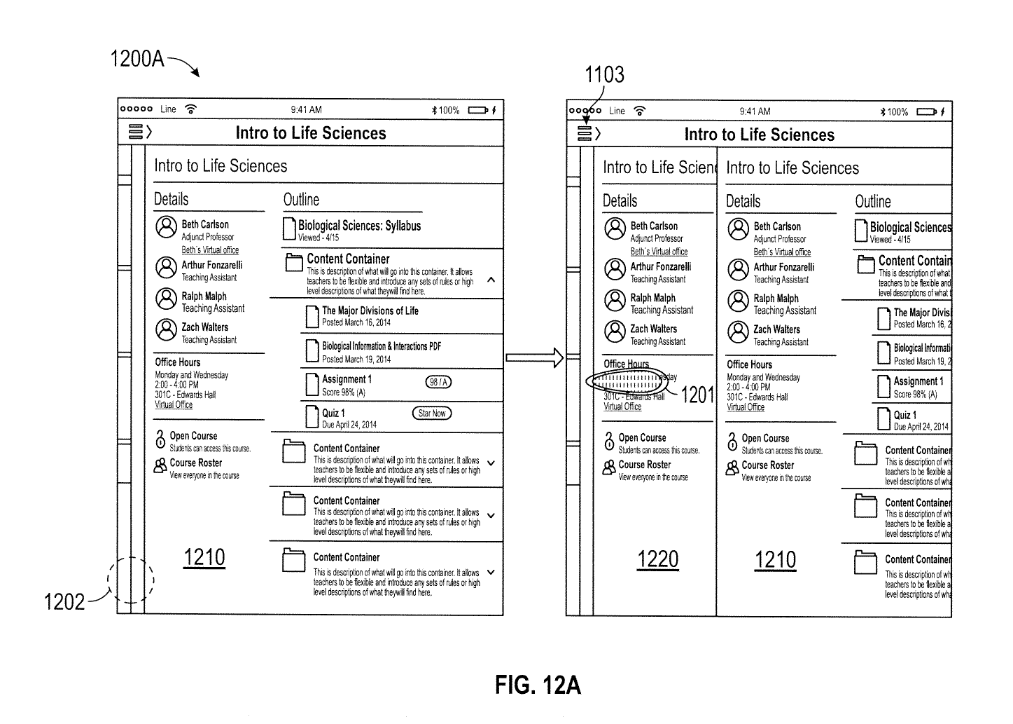

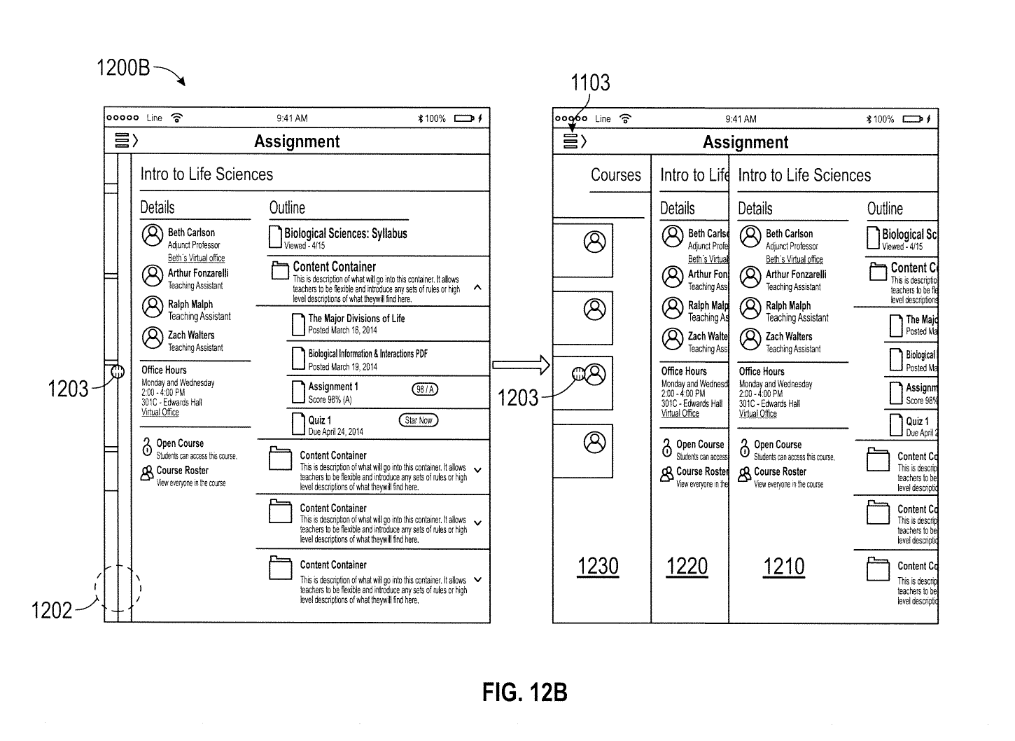

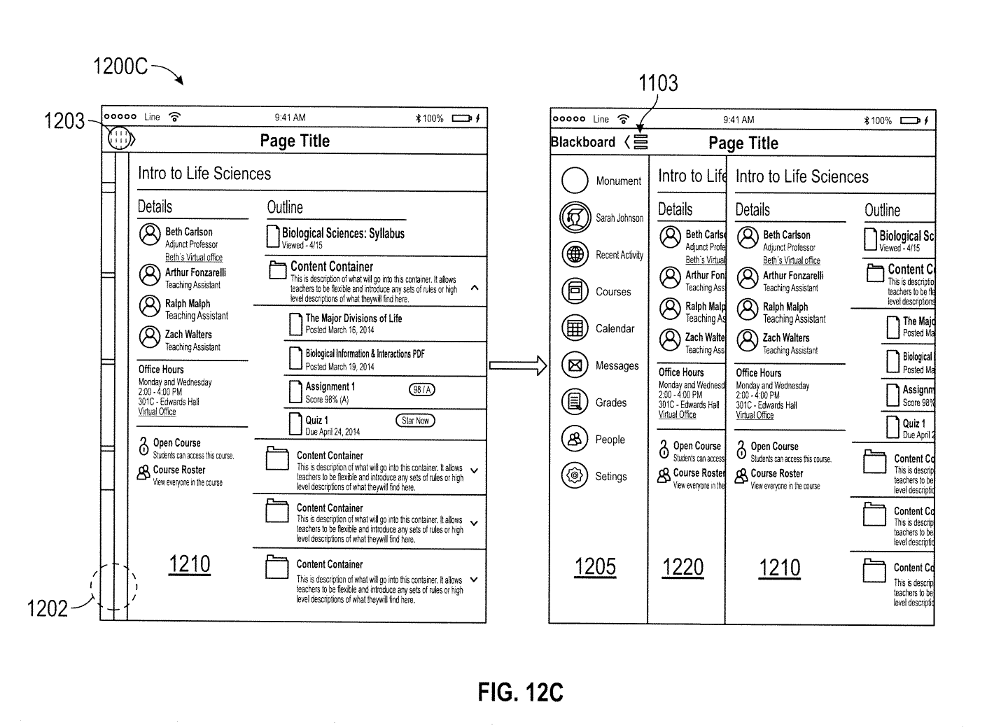

FIG. 12A illustrates a swipe to dismiss tool 1200A for tablet navigation through a datacenter hierarchy where a child layer 1210 is dismissed and the parent layer 1220 remains on display, according to some embodiments. When operating system 244 is one of iOS/Android, a child layer can be dismissed by swiping 1201 from the overlay area on the left 1202 where the parent content can still be seen. Each swipe 1201 will dismiss one layer at a time.

FIG. 12B illustrates tap to fan tool 1200B for tablet navigation through a datacenter hierarchy including an overlay area that receives a tap gesture, according to some embodiments. Tapping 1203 on the menu icon or anywhere in overlay area 1202 on the left will cause the child layers 1210, 1220, and 1230 to fan to the right. In some embodiments, layers 1210, 1220, and 1230 are evenly distributed across the page. In some embodiments, all pages 1210, 1220, and 1230 are revealed when overlay area 1202 is tapped 1203. When menu icon 1103 is tapped, the left navigation is revealed and in some embodiments the base layer is not revealed. In some landscape configurations where the navigation is exposed permanently, the base layer is not revealed. In either scenario, tapping on an item to view its contents will dismiss any item currently being displayed.

FIG. 12C illustrates tap to fan tool 1200C for tablet navigation through a datacenter hierarchy where a tap gesture 1203 on menu icon 1103 reveals a navigation tray 1205 is displayed, according to some embodiments. All other elements in FIG. 12C having the same reference numerals as in FIG. 12A are described in the same way as in FIG. 12A and therefore a description will not be repeated here.

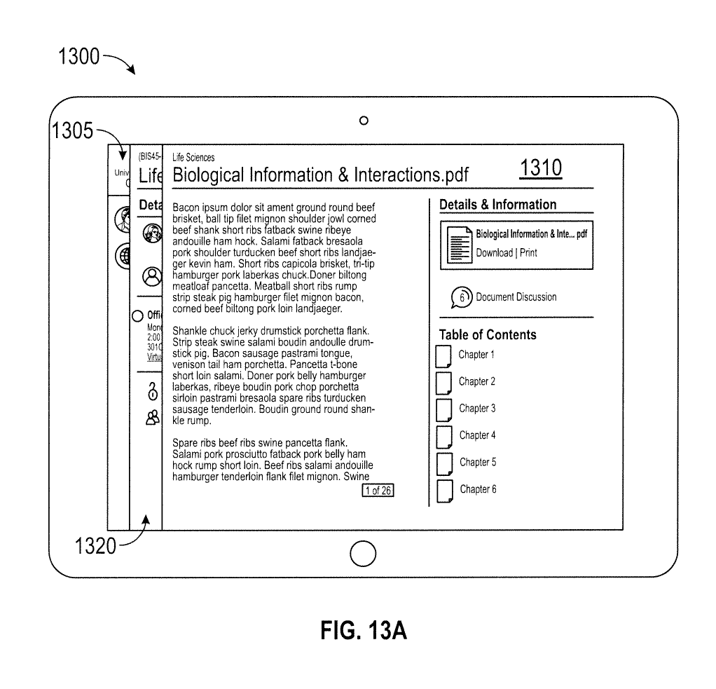

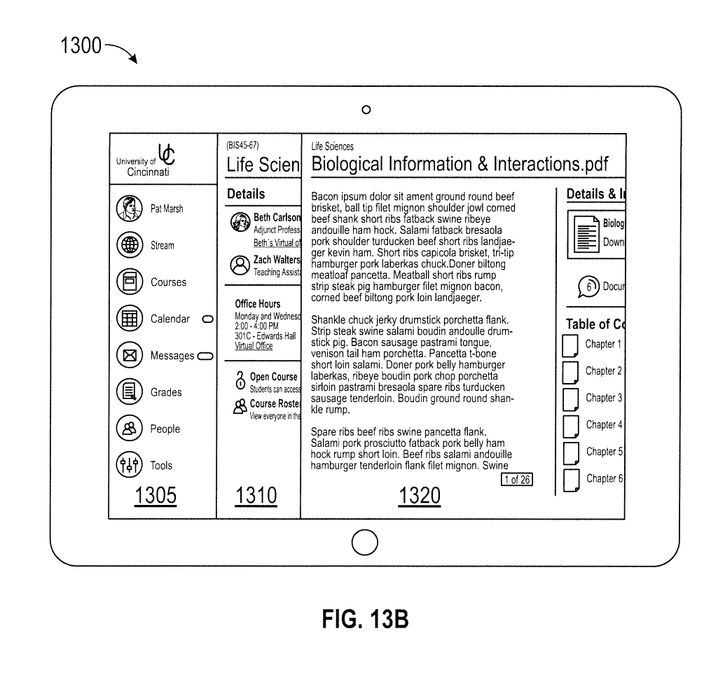

FIG. 13A illustrates a child page dismissal tool 1300 including a swipe to dismiss gesture in a tablet navigation through a datacenter hierarchy, according to some embodiments. FIG. 1300 shows a menu tray 1305 to the left of the display, and pages 1310 and 1320 corresponding to items in different hierarchical layers of the database. The user may dismiss any given item by a horizontal swipe gesture on the screen.

FIG. 13B illustrates a child page dismissal tool 1300 including a tap to fan gesture in a tablet navigation through a datacenter hierarchy, according to some embodiments. Accordingly, a tap gesture on item 1320 brings that item to the forefront of the display and puts old item 1310 in the back of a fan stack. Menu tray 1305 is displayed to the left of the screen.

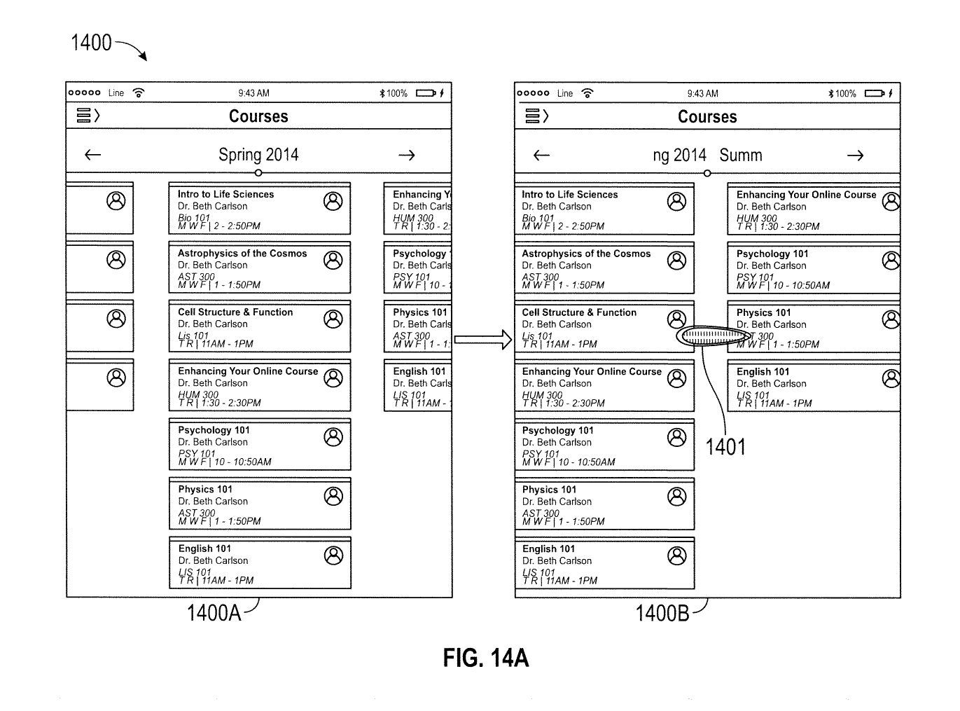

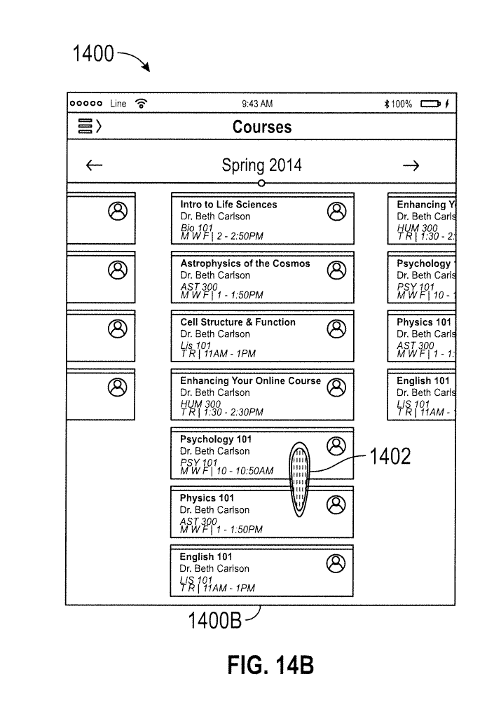

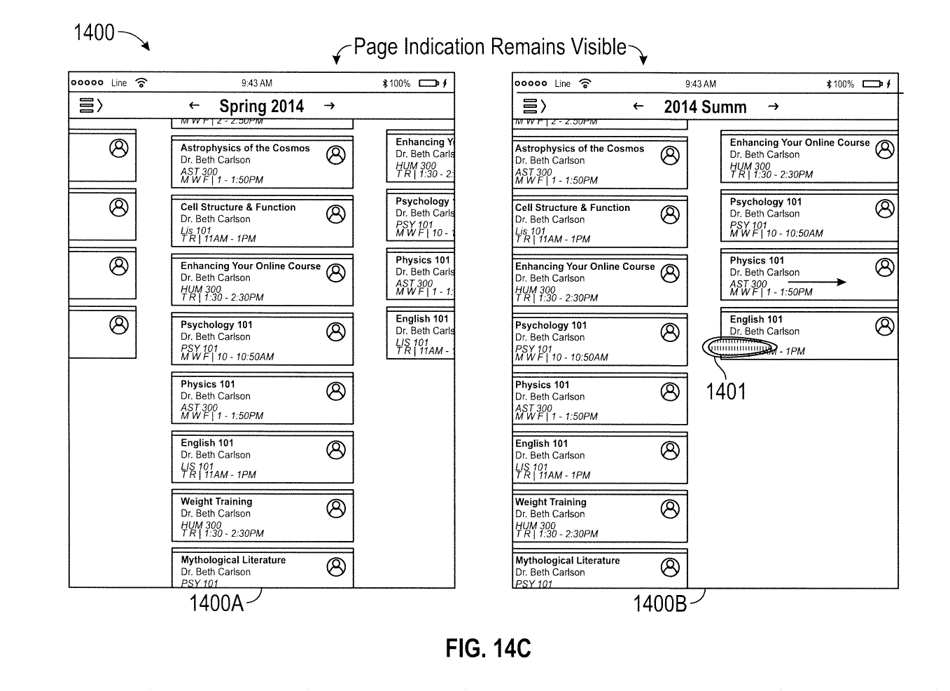

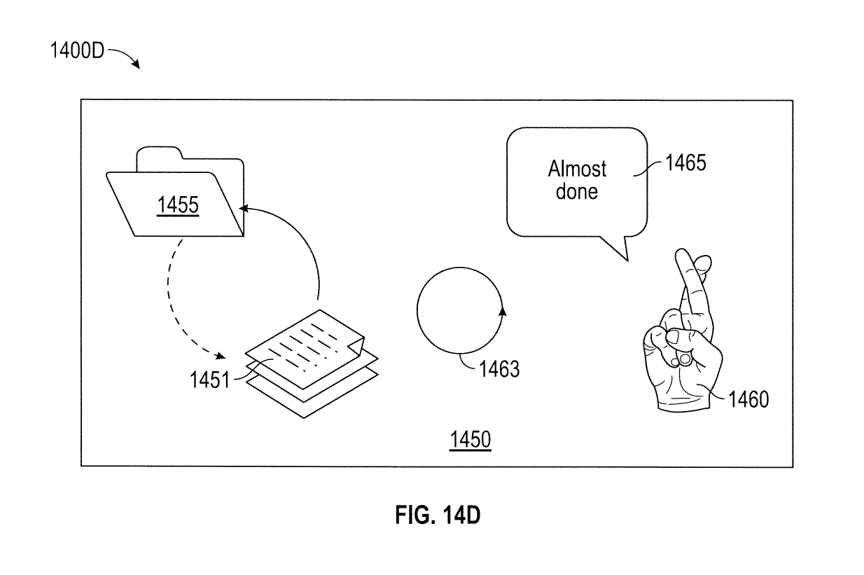

FIG. 14A illustrates a tablet navigation tool 1400 between sibling items in a datacenter hierarchy including a swipe through sections gesture 1401, according to some embodiments. Just as siblings are part of the same family, in some embodiments application 144 may include pages 1400A and 1400B that are related and desirably stand together, but maintain some form of independence. In a more general scope, sibling items are related pages that are accessed as a group. Sibling items 1400A and 1400B can be used to organize similar types of information over time—like a course timeline- or multi-variate content like the course page. Sibling items 1400A and 1400B allow users to perform a single search across all of the related pages and content types.

FIG. 14B illustrates tablet navigation tool 1400 between sibling items in a datacenter hierarchy including a vertical scrolling gesture 1402, according to some embodiments.

FIG. 14C illustrates a tablet navigation tool 1400 between sibling items 1400A and 1400B in a datacenter hierarchy including a header, according to some embodiments. Sibling pages 1400A and 1400B are organized on a left—right axis. Each sibling type maintains their own default entry point. As users swipe 1401 left and right between sibling pages, the title of the pages also changes. If the user scrolls 1402 a long sibling page, the title is pushed into the header bar, allowing users to maintain orientation within the application 144. Users can swipe 1401 left and right at any moment, to move between sibling pages 1400A and 1400B.

FIG. 14D illustrates a status icon displayed when a user is performing one of uploading or downloading a document to the datacenter. A graphical user interface system 1400D includes a display 1450 to provide a plurality of panels, each panel associated with a document in a datacenter. Display 1450 provides a status icon 1463 when a user is performing one of uploading or downloading a document 1451 to the datacenter 1455. System 1400D may include a geo-location module to provide a geo-location information to the processor, wherein the processor is further configured to adjust status icon 1463 according to the geo-location information.

In some embodiments, to adjust the status icon according to the geo-location information the processor adjusts a text language 1465 displayed on the display next to the status icon. Text language 1465 is selected according to the geo-location information. In some embodiments, to provide the status information the display provides a symbol 1460 associated to whether the uploading a first document or the downloading a second document is successful, unsuccessful, or yet incomplete.

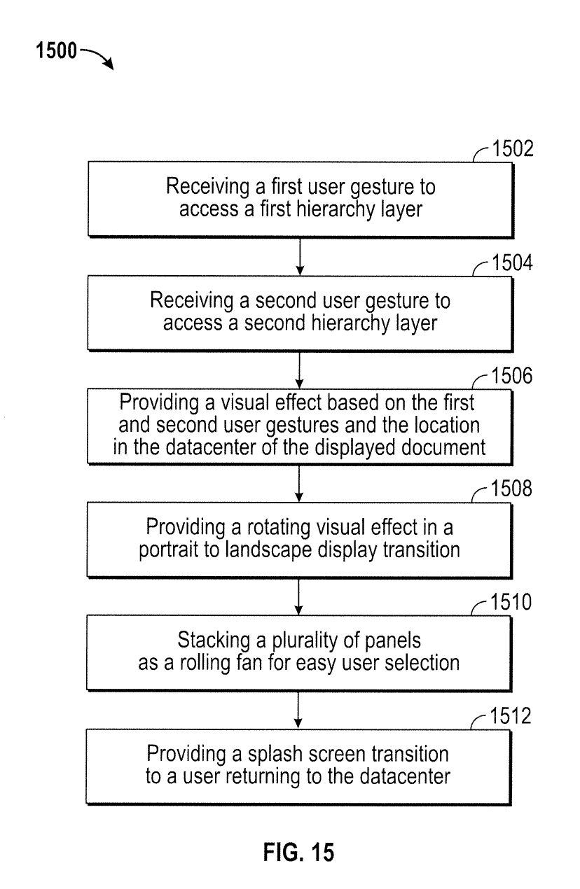

FIG. 15 is a flow chart illustrating steps in a method 1500 for navigating through a datacenter hierarchy in a mobile computer device, according to some embodiments. In some embodiments method 1500 is performed by a mobile computer device as disclosed herein (e.g., mobile computer device 132). Methods consistent with the present disclosure may include at least one, but not all of the steps in method 1500. Moreover, embodiments consistent with the present disclosure may include steps in method 1500 performed in a different order, or even simultaneously or overlapping in time.

Step 1502 includes applying a first gesture to access a first hierarchical level in a datacenter. Step 1504 includes applying a second gesture to access a second hierarchical level in the datacenter. Step 1506 includes providing a visual effect based on the input gesture and the location within the data center architecture of the displayed document. Step 1508 includes providing a rotating visual effect in a portrait to landscape display transition. Step 1510 includes stacking a plurality of panels as a rolling fan for easy user selection. Step 1512 includes providing a splash screen transition to a user returning to the datacenter.

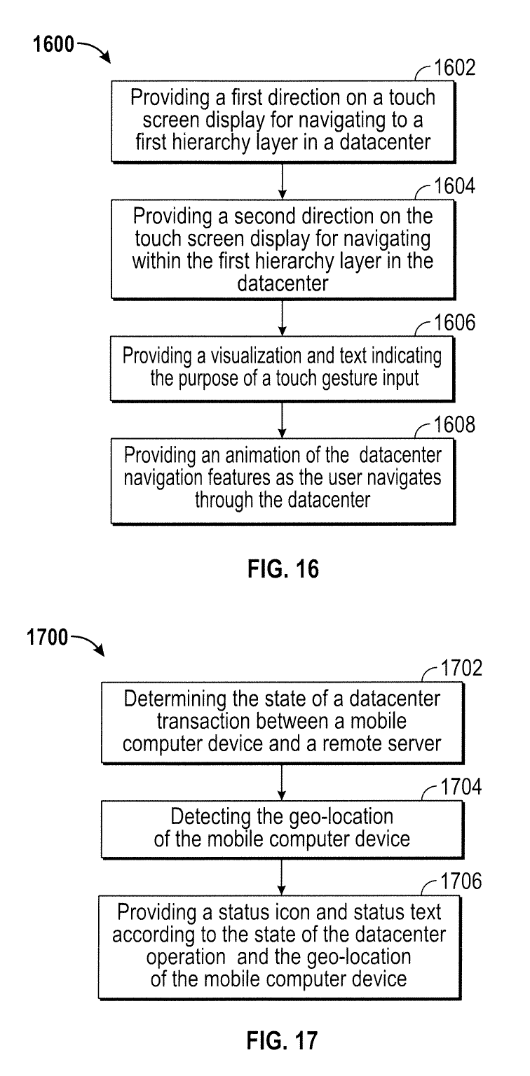

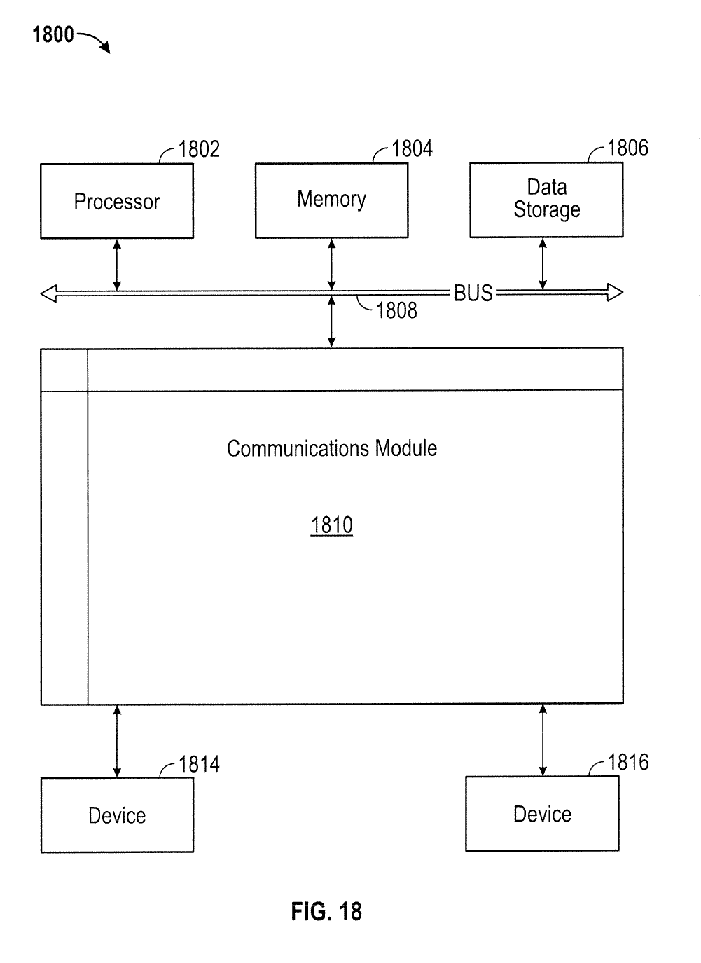

FIG. 16 is a flow chart illustrating steps in a method 1600 for navigating through a datacenter hierarchy in a mobile computer device, according to some embodiments. In some embodiments method 1600 is performed by a mobile computer device as disclosed herein (e.g., mobile computer device 132). Methods consistent with the present disclosure may include at least one, but not all of the steps in method 1600. Moreover, embodiments consistent with the present disclosure may include steps in method 1600 performed in a different order, or even simultaneously or overlapping in time.

Step 1602 includes providing a first direction on a touch screen display for navigating to a first hierarchical layer in the datacenter. Step 1604 includes providing a second direction on the touch screen display for navigating within the first hierarchical layer in the datacenter. Step 1606 includes providing a visualization and a text indicating the purpose of a touch gesture input. Step 1608 includes providing an animation of the datacenter navigation features as the user navigates through the datacenter. FIG. 16 is a flow chart illustrating steps in a method 1600 for displaying a state of a datacenter operation, according to some embodiments. Step 1602 includes determining the state of a datacenter operation between the mobile computer device and the remote server. Step 1604 includes identifying a geo-location of the mobile computer device. Step 1606 includes providing a status icon and a status text to the mobile computer device according to the state of the datacenter operation and the geo-location of the mobile computer device.

FIG. 17 is a block diagram illustrating an example computer system 1700 with which the personal computing device of FIG. 1 can be implemented. In certain aspects, computer system 1700 can be implemented using hardware or a combination of software and hardware, either in a dedicated server, integrated into another entity, or distributed across multiple entities.

Computer system 1700 (e.g., mobile delivery system 100, mobile computer device 132 and institutional client 120) includes a bus 1708 or other communication mechanism for communicating information, and a processor 1702 (e.g., processors 102, 122, and 134) coupled with bus 1708 for processing information. By way of example, computer system 1700 can be implemented with one or more processors 1702. Processor 1702 can be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1700 includes, in addition to hardware, code that creates an execution environment for the computer program in question, e.g., code that constitutes processor firmware, a protocol stack, a database management system, an operating system, or a combination of one or more of them stored in an included memory 1704 (e.g., memories 108, 128, and 140), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 1708 for storing information and instructions to be executed by processor 1702. Processor 1702 and memory 1704 can be supplemented by, or incorporated in, special purpose logic circuitry.

The instructions may be stored in memory 1704 and implemented in one or more computer program products, i.e., one or more modules of computer program instructions encoded on a computer readable medium for execution by, or to control the operation of, the computer system 1700, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, With languages, embeddable languages, and xml-based languages. Memory 1704 may also be used for storing temporary variable or other intermediate information during execution of instructions to be executed by processor 1702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1700 further includes a data storage device 1706 such as a magnetic disk or optical disk, coupled to bus 1708 for storing information and instructions. Computer system 1700 is coupled via communications module 1710 to various devices, such as an input device 1714 or an output device 1716. Device 1714 and 1716 may include other types of devices such as include data ports such as USB ports. Example communications modules 1710 (e.g., communications modules 104, 124, and 136) include networking interface cards, such as Ethernet cards and modems. In some embodiments, input device 1714 and output device 1716 may be integrated in the same I/O unit (e.g., I/O units 115, 125, and 135). Example input devices 1714 include a keyboard and a pointing device, e.g., a mouse or a trackball, by which a user can provide input to the computer system 1700. Other kinds of input devices 1714 are used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 1716 include display devices, such as a LED (light emitting diode), CRT (cathode ray tube), or LCD (liquid crystal display) screen, for displaying information to the user.

According to one aspect of the present disclosure, personal computing device 120 can be implemented using a computer system 1700 in response to processor 1702 executing one or more sequences of one or more instructions contained in memory 1704. Such instructions may be read into memory 1704 from another machine-readable medium, such as data storage device 1706. Execution of the sequences of instructions contained in main memory 1704 causes processor 1702 to perform the process steps described herein. One or more processors in a multi-processing arrangement may also be employed to execute the sequences of instructions contained in memory 1704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 1700 includes servers and personal computer devices, such as servers 110 and personal computing devices 120, described in detail above. A personal computing device and server are generally remote from each other and typically interact through a communication network. The relationship of client and server arises by virtue of computer programs running on the respective computers and having a client-server relationship to each other. Computer system 1700 can be, for example, and without limitation, a desktop computer, laptop computer, or tablet computer. Computer system 1700 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 1702 for execution. Such a medium may take many forms, including, but not limited to, non-volatile media, volatile media, and transmission media. Non-volatile media include, for example, optical disks, magnetic disks, or flash memory, such as data storage device 1706. Volatile media include dynamic memory, such as memory 1704. Transmission media include coaxial cables, copper wire, and fiber optics, including the wires that comprise bus 1808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any One of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C. To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. A graphical user interface system comprising:
a display configured to provide a plurality of panels, each panel associated with a document in a datacenter, wherein the datacenter comprises an architecture having a plurality of hierarchy layers, each hierarchy layer storing at least a document;
a memory storing commands; and
a processor coupled to the display and configured to execute the commands to cause the graphical user interface to navigate through the datacenter architecture by:
receiving a first user gesture to access a first hierarchy layer in the datacenter;
receiving a second user gesture to access a second hierarchy layer in the datacenter; and
displaying in the display a visual effect when at least one of the first hierarchy layer and the second hierarchy layers are accessed.

2. The system of claim 1, wherein the processor is coupled to a sensor configured to detect a physical rotation of the graphical user interface, and the commands executed by the processor cause the display to provide a rotating visual effect to the user when the sensor detects a physical rotation of the graphical user interface.

3. The system of claim 1, wherein the commands executed by the processor further cause the display to stack a plurality of panels associated with documents in the same hierarchy layer in a rolling fan for user selection.

4. The system of claim 1, wherein the commands executed by the processor further cause the display to form a splash screen for a user returning to the datacenter.

5. The system of claim 1, wherein the processor is coupled to a communications module to access the datacenter in a remote server, receive the document from the remote server, and upload a second document into the datacenter.

6. The system of claim 5, wherein the processor is coupled to a geo-positioning location module configured to provide a geo-location of a mobile computing device comprising the graphical user interface system, and wherein the processor adjusts the status icon according to the geo-location of the mobile computer device.

7. The system of claim 1, wherein the datacenter comprises academic records in an educational institution, and the at least one document comprises one of a course list, a course syllabus, a course material, and a course assignment.

8. The system of claim 1, wherein the first user gesture comprises a horizontal finger swipe, and the first hierarchy layer in the datacenter is the current hierarchy layer.

9. The system of claim 1, wherein the second user gesture comprises a tap, and the second hierarchy layer in the datacenter is a higher hierarchy layer relative to the first hierarchy layer.

10. The system of claim 1, wherein the first user gesture comprises a vertical finger swipe at a first speed, and the second user gesture comprises a vertical finger swipe at a second speed, the second speed higher than the first speed.

11. A mobile computer device, comprising:
a communications module configured to access a datacenter in a remote server through a network, the datacenter having an architecture comprising a plurality of hierarchy levels;
a display configured to provide a plurality of panels, each panel associated with a document in the datacenter,
a memory storing commands; and
a processor configured to execute the commands to cause the display to navigate through the datacenter architecture by:
receiving a first user gesture to access a first hierarchy layer in the datacenter;
receiving a second user gesture to access a second hierarchy layer in the datacenter; and
displaying, in the display, a visual effect when at least one of the first hierarchy layer and the second hierarchy layer are accessed.

12. The mobile computer device of claim 7, further comprising a sensor module to provide an orientation information to the processor, and wherein the processor is configured to adjust the display to provide the plurality of panels according to the orientation information.

13. The mobile computer device of claim 7, further comprising a geo-positioning locator module, wherein the processor adjusts the display according to the geo-location of the mobile computer device.

14. A non-transitory, computer-readable medium comprising instructions which, when executed by a processor circuit coupled to a display and a memory, the memory comprising a graphical user interface, cause the display to perform a method comprising:
receiving a first user gesture to access a first hierarchy layer in the datacenter;
receiving a second user gesture to access a second hierarchy layer in the datacenter; and
displaying in the display a visual effect when at least one of the first hierarchy layer and the second hierarchy layers are accessed.

15. The computer-readable medium of claim 14, wherein the processor is coupled to a sensor configured to detect a physical rotation of the graphical user interface, and the commands executed by the processor cause the display to provide a rotating visual effect to the user when the sensor detects a physical rotation of the graphical user interface

16. The computer-readable medium of claim 14, wherein the commands executed by the processor further cause the display to stack a plurality of panels associated with documents in the same hierarchy layer in a rolling fan for user selection.

17. The computer-readable medium of claim 14, wherein the commands executed by the processor further cause the display to form a splash screen for a user returning to the datacenter.

18. The computer-readable medium of claim 14, wherein the processor is coupled to a communications module to access the datacenter in a remote server, receive the document from the remote server, and upload a second document into the datacenter.

19. The computer-readable medium of claim 18, wherein the processor is coupled to a geo-positioning location module configured to provide a geo-location of a mobile computing device comprising the graphical user interface system, and wherein the processor adjusts the status icon according to the geo-location of the mobile computer device.

20. The computer-readable medium of claim 14, wherein the datacenter comprises academic records in an educational institution, and the at least one document comprises one of a course list, a course syllabus, a course material, and a course assignment.

21. A method for navigating through a datacenter hierarchy in a mobile computer device, the method comprising:
receiving a first user gesture to access a first hierarchy layer in the datacenter architecture;
receiving a second user gesture to access a second hierarchy layer in the datacenter architecture; and
providing a visual effect based on the first and second user gestures and the location in the datacenter of a document displayed on the display.

22. The method of claim 21, further comprising providing a visual effect in a portrait to landscape display transition.

23. The method of claim 21, further comprising stacking a plurality of panels as a rolling fan for easy user selection, wherein each of the plurality of panels is a document in the datacenter.

24. The method of claim 21, further comprising providing a splash screen transition to a user returning to the datacenter.

25. The method of claim 21, further comprising identifying when the mobile computer device is one of a smartphone or a tablet computer to adjust a display of the visual effect.

26. A graphical user interface system comprising:
a display configured to provide a plurality of panels, each panel associated with a document in a datacenter;
a memory storing commands; and
a processor coupled to the display and configured to execute the commands to cause the display to provide a status icon when a user is performing one of uploading a first document to the datacenter, or downloading a second document from the datacenter.

27. The system of claim 26, further comprising a geo-location module to provide a geo-location information to the processor, wherein the processor is further configured to adjust the status icon according to the geo-location information.

28. The system of claim 27, wherein to adjust the status icon according to the geo-location information the processor adjusts a text language displayed on the display next to the status icon, the text language selected according to the geo-location information.

29. The system of claim 26, wherein to provide the status information the display provides a symbol associated to whether the uploading a first document or the downloading a second document is successful.

30. A method for handling a graphical user interface in a network connection between a mobile computer device and a remote server, the method comprising:
determining the state of a datacenter transaction between the mobile computer device and the remote server;
detecting a geo-location of the mobile computer device; and
providing a status icon and status text according to the state of the datacenter operation and the geo-location of the mobile computer device.

31. The method of claim 30, wherein to adjust the status icon according to the geo-location information comprises adjusting a text language displayed on the display next to the status icon, the text language selected according to the geo-location information.

32. A method for handling a graphical user interface in a network connection between a mobile computer device and a remote server hosting a datacenter, the method comprising:
providing a first input direction on a touch screen display for navigating between a plurality of hierarchy layers in the datacenter; and
providing a second input direction on the touch screen display for navigating within each of the plurality of hierarchy layers in the datacenter.

33. The method of claim 32, further comprising:
providing a visualization and a text indicating the purpose of a touch gesture input; and
providing an animation of the datacenter navigation features to the user, while the user navigates through the datacenter.

34. The method of claim 32, wherein the datacenter comprises academic records in an educational institution, and further comprising opening at least one document in the datacenter, the document comprising one of a course list, a course syllabus, a course material, and a course assignment.

35. The method of claim 32, wherein the first input direction comprises a horizontal direction, and the plurality of hierarchy layers in the datacenter comprises the current hierarchy layer.

36. The method of claim 32, wherein the second input direction comprises a vertical direction, and the plurality of hierarchy layers in the datacenter comprises a higher hierarchy layer relative to the first hierarchy layer.

37. The method of claim 32, further comprising:
receiving a first user gesture comprising a horizontal finger swipe; and
receiving a second user gesture comprising a vertical finger swipe.

38. The method of claim 32, further comprising:
identifying whether the mobile computer device is a smartphone or a tablet device; and
adjusting the touch screen display according to the identification.

39. The method of claim 38, wherein adjusting the touch screen display according to the identification comprises providing a menu option on the side of a panel display of a document in the datacenter when the mobile computer device is a tablet device.

40. The method of claim 38, wherein adjusting the touch screen display according to the identification comprises displaying at least one of the plurality of hierarchy layers on the display when the mobile computer device is a smartphone.
